(19) United States
(12) Patent Application Publication
(10) Pub. No.: US 2025/0329229 A1
(43) Pub. Date: Oct. 23, 2025

(54) SYSTEM AND METHOD FOR ENHANCED GAME OF CHANCE DATA TRANSMISSION AND GAME SUBSCRIPTION AUTOMATION

(71) Applicant: HEX-PERPETUAL ENTERPRISES INC, Pallisades, NY (US)

(72) Inventor: Benjamin Noah Brown, Palisades, NY (US)

(73) Assignee: HEX-PERPETUAL ENTERPRISES INC, Palisades, NY (US)

(21) Appl. No.: 19/186,226

(22) Filed: Apr. 22, 2025

Related U.S. Application Data
(60) Provisional application No. 63/637,740, filed on Apr. 23, 2024.

(51) Int. Cl. G07F 17/32

(52) U.S. Cl. CPC G07F 17/329; G07F 17/323; G07F 17/3237; G07F 17/3269

(57) ABSTRACT

Described is a Hex-Perpetual engine for driving a calendar-time-based internet lottery system/global gaming platform. Participants scattered across the globe can play any of the six Hex-Perpetual games (The Minute, The Hour, The Day, The Week, The Month, or The Year). The online lottery games of chance include the ability to play one or more independent games, which are played alone or simultaneously for a set of cycles, with each cycle having a respective time duration for a respective game. The system guarantees standardized timing across regions, optimizing participation. After each interval, randomized drawings are distributed pooled funds as prizes, offering payouts of multiple sizes and higher winning probabilities. Participants can join forces with other players, increasing their odds by splitting pots with their group. Players can also set “lucky times” subscriptions, allowing the platform to participate on behalf of the player at different moments.

### CROSS-REFERENCE TO RELATED APPLICATIONS

The present application claims priority to and the benefit of U.S. Provisional Patent Application Ser. No. 63/637,740, filed Apr. 23, 2024, the contents of which are herein incorporated by reference as if set forth herein in its entirety.

### TECHNICAL FIELD

The present disclosure relates generally to enhancing and automating execution of online lotteries or online games of chance, and more specifically, to automating subscription and notification associated with the online games of chance.

### SUMMARY

A method for operating online games of chance is disclosed. The method includes: receiving purchases of chances for winning prizes for online games of chance; initiating randomized drawings for winning the prizes for the online games of chance; and selecting, based on the randomized drawings, at least one prize winner for each cycle of the online games of chance. The online games of chance can include at least two independent games including a first game and a second game. The first game can be played continuously for first cycles with each cycle having a first time duration and the second game can be played continuously for second cycles with each cycle having a second time duration. Selecting at least one prize winner for each cycle of the online games of chance includes selecting a respective prize winner for each cycle of the first game at end of the first time duration and selecting a respective prize winner for each cycle of the second game at end of the second time duration. Standardized time can be used for each cycle of the first game and each cycle of the second game such that each cycle of a respective game has a same start time and a same end time for participants across different regions or different countries.

A non-transitory computer readable medium storing instructions operable to cause one or more processors to perform operations for executing or operating an online game of chance is disclosed. The operations include: receiving purchases of chances for winning prizes for online games of chance; initiating randomized drawings for winning the prizes for the online games of chance; and selecting, based on the randomized drawings, at least one prize winner for each cycle of the online games of chance. The online games of chance can include at least two independent games including a first game and a second game. The first game can be played continuously for first cycles with each cycle having a first time duration and the second game can be played continuously for second cycles with each cycle having a second time duration. Selecting the at least one prize winner for each cycle of the online games of chance includes selecting a respective prize winner for each cycle of the first game at end of the first time duration and selecting a respective prize winner for each cycle of the second game at end of the second time duration. Standardized time can be used for each cycle of the first game and each cycle of the second game such that each cycle of a respective game has a same start time and a same end time for participants across different regions or different countries.

A system that includes a memory subsystem storing instructions and processing circuitry is disclosed. The processing circuitry is configured to execute the instructions to: receive purchases of chances for winning prizes for online games of chance; initiate randomized drawings for winning the prizes for the online games of chance; and select, based on the randomized drawings, at least one prize winner for each cycle of the online games of chance. The online games of chance can include at least two independent games including a first game and a second game. The first game can be played continuously for first cycles with each cycle having a first time duration and the second game can be played continuously for second cycles with each cycle having a second time duration. Selecting the at least one prize winner for each cycle of the online games of chance includes selecting a respective prize winner for each cycle of the first game at end of the first time duration and selecting a respective prize winner for each cycle of the second game at end of the second time duration. Standardized time can be used for each cycle of the first game and each cycle of the second game such that each cycle of a respective game has a same start time and a same end time for participants across different regions or different countries.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is an example illustration of a Hex-Perpetual game.

FIG. 1B is a block diagram of an example of a system for executing the Hex-Perpetual game in accordance with implementations of this disclosure.

FIG. 2 depicts an illustrative processor-based, computing device.

FIG. 3 is a flowchart of an example of a technique for executing an online game of chance.

FIG. 4 is a flowchart of an example of a technique for subscribing and/or configuring participation time and executing an online game of chance.

FIG. 4A is an example of charitable giving or donation page or screen.

FIG. 5 is a flowchart of an example of a technique for transmitting notification associated with historic and/or real-time online game of chance data.

FIG. 6, which includes 6A-6D2, is a flowchart of a second example of a technique for executing an online game of chance. FIGS. 6A-6D2 are inter-connected flowcharts.

FIG. 7, which includes 7A-7F, is a flowchart of a second example of a technique for subscribing and/or configuring participation time and executing an online game of chance. FIGS. 7A-7F are inter-connected flowcharts.

FIGS. 7G-I are examples of subscribing and/or configuring participation time pages or screens.

FIG. 8 is a flowchart of an example of a technique for transmitting notifications associated with the execution of an online game of chance.

FIG. 9 is a flowchart of an example of a technique for creating a prize pool and for receiving participants that want to join the prize pool for an online game of chance.

FIG. 9A-C are example illustrations of group play.

FIG. 10, which includes 10A-10C, is a flowchart of an example of a technique for utilizing advertisements and surveys to promote an online game of chance. FIGS. 10A-10C are inter-connected flowcharts.

FIG. 10D is an example of an advertisement page or screen.

FIGS. 11A-11B are illustrations that illustrate an example breakdown of total prize(s) and prizes for a minute game, an hour game, a week game, a month game, and a year game of Hex-Perpetual games, and a user interface which participants can interact with to participate in the Hex-Perpetual games, respectively.

### DETAILED DESCRIPTION

The lottery, which is a game of chance, can take a form of gambling and provide participants (e.g., players) with the chance to win substantial prizes, often in the form of money. Particularly, the lottery involves purchasing a ticket with a set of numbers, and if these numbers match the ones drawn in a random drawing, the ticket holder (e.g., player, participant) wins a prize.

The traditional lottery system often requires participants to buy physical tickets from authorized vendors. However, the advent of the internet has led to the emergence of online lottery systems, which offer several advantages over their traditional counterparts.

Online lottery system allow players to purchase tickets and participate in a variety of lottery games via the internet. For example, lotto.com allows participants to participate in many different lottery games including MEGA millions, Powerball, etc. These platforms offer increased accessibility and convenience, as participants can engage in the lottery from the comfort of their own homes or on the go using their mobile devices.

However, for instance, participants can want to subscribe to participate (e.g., play) in the lottery game or participate at a certain date. Moreover, for instance, participants can want to see real-time or past statistical data about local winners, participation level, and/or total prize(s) depending on different locations. Moreover, for instance, participants can want more interactive engagement with the lottery game for diversion purposes. Moreover, for instance, participants can want to experience the availability of multiple lottery games that can be played in which they can directly participate and see the result of the draw on the same minute, same hour, and/or same day.

Nevertheless, there is no online lottery system that: [1] utilizes game duration of each game cycle based on simulation of a timing system (of a minute, an hour, a day, a week, a month, a year), calendar time, and/or standardized time (e.g., Greenwich mean time); [2] offers automatic play subscription option; [3] offers custom option where participants can choose to enter a draw, or both enter and see the result of the draw on that very custom date (as the game duration simulates the timing system or calendar time); and [4] transmits or displays various notifications including past and real-time statistical data of participation level, total prize(s), and/or prize winner based on geographical region that the participant is located in along with other interactive notifications to actively engage or communicate with the participants.

Implementations in accordance with this disclosure address issues addressed above. For example, implementations include online lottery games (e.g., minute game, hour game, week game, month game, and year game) which utilize game duration of each game cycle based on the simulation of the timing system, the calendar time, and/or the standardized time, such that participants can participate, play, or enter the game(s) every minute, every hour, every week, every month, and/or every year. Moreover, participants can participate or enter the draw periodically through subscription option or participate or enter the draw at a certain date of participant preference by utilizing custom date participation option. Moreover, participants can participate or enter the draw and see the result of the draw simultaneously on that very date depending on which game(s) the participants play. Moreover, the standardized time can be used for each cycle of each game such that each cycle of a respective game has a same start time and a same end time for participants across different regions or different countries. Moreover, implementations can include transmitting or displaying various notifications including past and real-time statistical data of participation level, total prize(s), and/or prize winner based on geographical region that the participants are located in along with other interactive notifications to actively engage or communicate with the participants.

Reference will now be made in detail to certain illustrative implementations, examples of which are illustrated in the accompanying drawings. Wherever possible, the same reference numbers will be used throughout the drawings to refer to the same or like items.

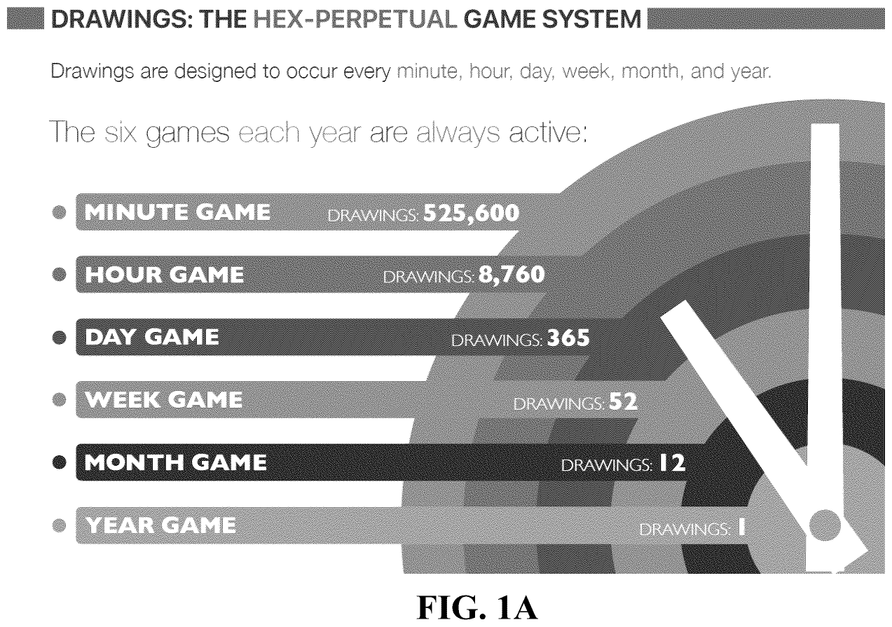

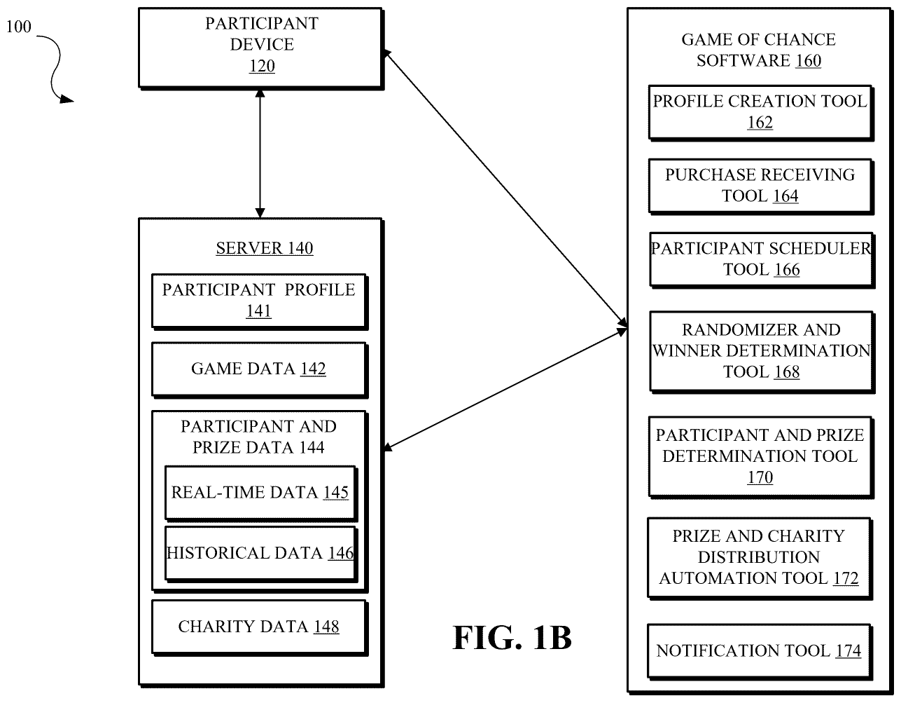

FIG. 1A is an example illustration of a Hex-Perpetual game.

The Hex-Perpetual game can be an online lottery game or online game(s) of chance, which can be played by participants across the world through a participant device (e.g., computing device that includes personal computer, mobile phone, tablet computer, a participant device 120 described below, etc.).

The Hex-Perpetual game can include a minute game, an hour game, a day game, a week game, a month game, and a year game. In implementations, the Hex-Perpetual game can be based on a unit of time or time interval including, but not limited to, minute, hour, day, week, month, and/or year. The descriptions herein are applicable to any such unit of time or time interval. Each of these games can be independent games and time-specific games (with specific duration) as the names of the games reflect upon. For example, the minute game can have a duration of (e.g., played for) a minute, the hour game can have a duration of an hour, the day game can have a duration of a day, and the year game can have a duration of a year. For example, as these are the games of chances or lotteries, participants can participate (e.g., act of entering or applying for a specific drawing or round of a lottery) in a draw (e.g., prize draw) or play the lottery by buying one or more tickets. For example, participants can have a minute to enter (i.e., buy a ticket for) a cycle (e.g., a round) of the minute game, an hour to enter a cycle of the hour game, a day to enter a cycle of the day game, a week to enter a cycle of the week game, a month to enter a cycle of the month game, and a year to enter a cycle of the year game. After or at the end of each cycle, there can be an automatic drawing (e.g., prize drawing) process based on a randomized drawing method, which would pick at least one winner participant for each cycle for each game. Moreover, there can be multiple winners for each cycle for each game. For example, there can be five winners for each cycle for each game, with a first prize winner collecting a first largest portion of a total prize(s) (e.g., pot, total amount of money that can be won), a second prize winner collecting a second largest portion of the pot, a third prize winner collecting a third largest portion of the of the pot, a fourth prize winner collecting a fourth largest portion of the pot, and a fifth prize winner collecting a fifth largest portion of the pot. In some implementations, there can be more or less than five winners for each cycle for each game.

In some implementations, the pot can be formed or based on amount of ticket sales or money that is collected from the participants to participate in each cycle for each game. In such scenario, when there are more tickets or more money collected for participation, the pot would increase, as the pot is formed based on the number of ticket sales or the money collected from participants to participate in each cycle for each game. Once the prize(s) are distributed, the pot can include leftover (certain portion of the pot) which can include or be distributed as overhead cost (e.g., operational cost), profit, and/or charity cost (which can be distributed to a charity).

Moreover, each of these games can be played continuously. For example, each of these games can be played continuously at least for a set of cycles. For example, for purposes of illustration, assuming that the day game has a set of 365 cycles, then the day game can be played continuously for 365 times for one year. Moreover, for example, assuming that the set of cycles last for one year for all of the games, then the minute game can have 525,600 cycles and drawings, the hour game can have 8,760 cycles and drawings, the day game can have 365 cycles and drawings, the week game can have 52 cycles and drawings, the month game can have 12 cycles and drawings, and the year game can have one cycle and one drawing.

Moreover, such games can be played based on a standardized time such that participants across different regions or different countries can participate at the same standardized time. For example, Greenwich Mean Time can be used as the standardized time. For example, participants across different regions or different countries can use their participant devices to participate in the games at a same start time and a same end time for each cycle for each different game, as the games are played and/or displayed (e.g., on an user interface of the participant device) based on the standardized time.

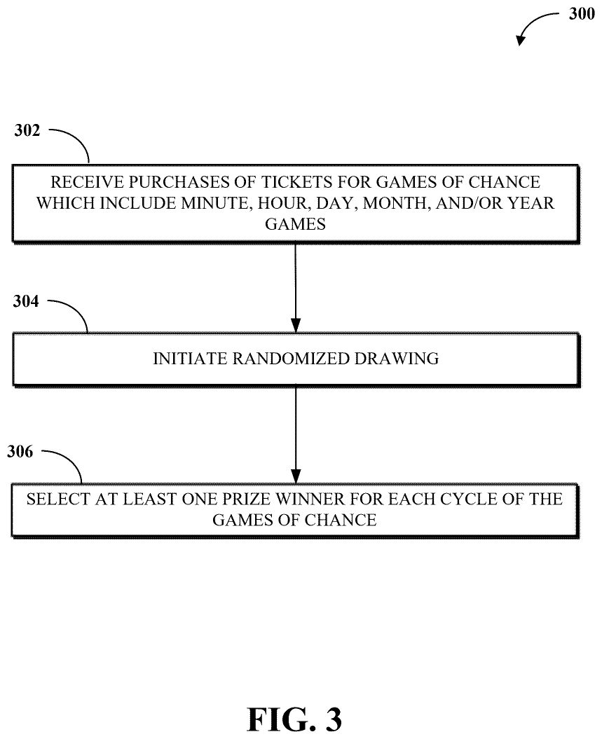

FIG. 1B is a block diagram of an example of a system 100 for executing the Hex-Perpetual game in accordance with implementations of this disclosure. The system 100 can include a participant device 120, a server 140, and a game of chance software 160. In implementations, the server 140 and the game of chance software 160 (or application) can be implemented as a Hex-Perpetual engine. In some implementations, the system 100 and/or the Hex-Perpetual engine can execute method and techniques described in FIGS. 3-10C.

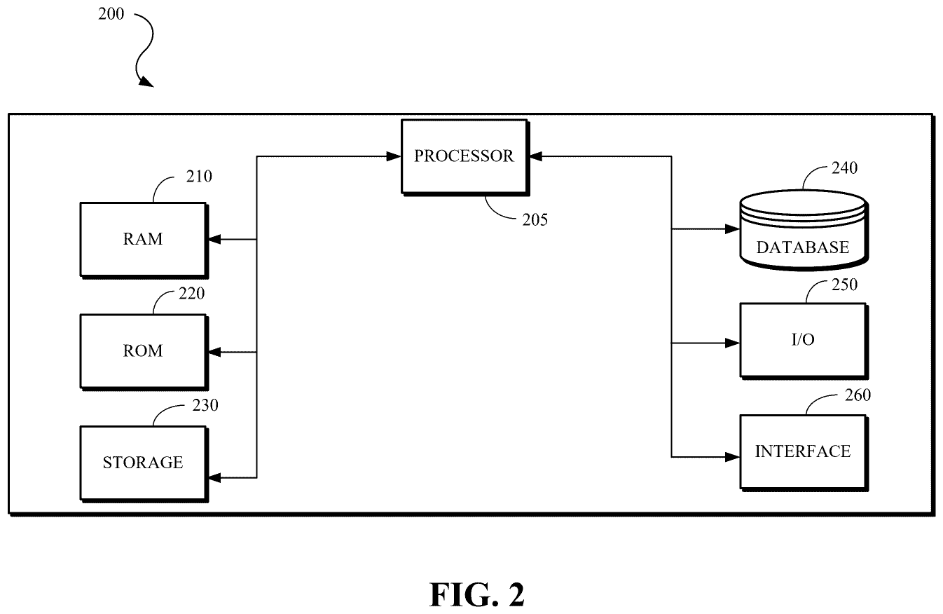

The participant device 120 can be a computing device (such as a computing device 200 shown in FIG. 2) including an end-user device, information appliances, mobile computers, laptops, handheld computers, personal media devices, smartphones, notebooks, notepads, and tablets, cloud-based platform, distributed computing platform, and the like. The participant device 120 can include or run a software or an application (e.g., the game of chance software 160) for executing or operating the online game(s) of chance in accordance with implementations of this disclosure. Clients, users, or participants can be users of the participant device 120.

The participant device 120 can be connected to or in communication with (collectively “connected to”) a server 140 via a network. The connections between the participant device 120 and the server 140 can be established as part of operating or executing the online game(s) of chance (e.g., the Hex-Perpetual game) techniques described herein. The system 100 and the components thereof can include other elements which can be desirable or necessary to implement the devices, systems, compositions, and methods described herein. The network can be and/or can include the internet, an intranet, a local area network (LAN), a wide area network (WAN), a public network, a private network, network gateway, a cellular network, a Wi-Fi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, an IP network, cable, satellite, hybrid coaxial systems, fiberoptic systems, 5G, and like including any combinations thereof. In some implementations, the network can contain one or more servers, network elements or devices, and the like.

The server 140 can be database(s), server(s), or any combination thereof. The server 140 can store, run, and transmit data or instructions associated with executing or operating the online game(s) of chance. The server 140 can store data that can be retrieved by the participant device 120 when the participant device 120 is used in conjunction with a game of chance software 160. For example, while or when the participant device 120 and/or the server 140 run the game of chance software 160, the software can contain built-in logic or instructions to connect to the server 140, and the connection can be facilitated through network protocols between the participant device 120 and the server 140 exchanging data packets.

For example, the server 140 can be a dedicated server, a virtual private server (VPS), a content delivery network (CDN), an application server, a cloud storage solution, a cloud server, a database server (e.g., SQL databases), a web server, Backend-as-a-Service (BaaS) platforms, etc. For example, the dedicated server can offer uninterrupted access and high-speed processing, which can be beneficial for applications managing an extensive library of files without shared resource interference. For example, the VPS can provide scalable storage and processing capabilities on a budget. For example, the CDN can ensure fast delivery of data across the globe by caching content in multiple geographical locations. As such, the CDN can minimize buffering or download delays. Moreover, for example, the CDNs can distribute content to multiple server locations worldwide and users can access data from the nearest server, which can ensure low latency and fast load. For example, the cloud storage solution can handle vast amounts of data and offer high redundancy (e.g., can store multiple copies of data to ensure data availability and protect against data loss). For example, the database server can be efficient in storing and managing structured data.

The server 140 can include or store at least a participant profile 141, game data 142, participant and prize data 144, and charity data 148. For example, the participant profile 141 can be or include any information associated with identifying participant(s), participant profile(s), purchase information (e.g., lottery ticket purchase or purchase of a chance for winning a prize), history of purchase, and/or relevant information associated with playing the online game(s) of chance.

For example, game data 142 can include instructions or information related to execution or operation of the online game(s) of chance. For example, the game data 142 can include data related to executing or operating the minute game, the hour game, the day game, the week game, the month game, and the year game of the Hex-Perpetual game, as described above with respect to FIG. 1A.

For example, the participant and prize data 144 can include historical data 146 and real-time data 145 associated with how many participants have participated in each cycle of each game in history and in real-time, and corresponding history of and real-time prize data. For example, since the total prize(s) or the pot of each cycle of each game can be formed or based on amount of ticket sales or money (e.g., purchase) that is collected from the participants to participate in each cycle of each game, the total prize(s) can be directly proportional to, and vary depending on the amount of ticket sales, the money that is collected, and/or the number of participants (assuming that some of the participants do not buy a disproportionably large amount of tickets). Accordingly, the historical data 146 and the real-time data 145 can include information associated with history of participation (that includes the number of participants in each cycle of each game), real-time participation (that includes real-time number of participants in ongoing or current cycle of each game), history of total prize(s) of each cycle of each game, and real-time total prize(s) of ongoing or current cycle of each game. Moreover, such historical data 146 and real-time data 145 can be based on or include along with corresponding geographical information of local regions, countries, and/or continents. Moreover, such historical data 145 and real-time data 145 can be retrieved by the participant device 120 for display on a map based on the geographical information, and/or within certain distance or radius of real-time location of the participant device 120.

For example, the charity data 148 can include charity list to where the server 140 is configured to distribute a certain portion of the total prize(s). For example, as described above, once the prize(s) are distributed to the prize winners (among the participants), the pot can include leftover (certain portion of the pot) which can include overhead cost (e.g., operational cost), profit, and/or charity cost (which can be distributed to a charity). To put it another way, a first portion of the total prize(s) can be distributed to the prize winners, a second portion of the total prize(s) can be distributed to an operator (e.g., company or entity that operates the online game(s) of chance) as operational cost, a third portion of the total prize(s) can be distributed to the operator as profits, and/or a fourth portion of the total prize(s) can be distributed to one or more assigned charities. Accordingly, one or more assigned charities may be included in the charity data 148.

The game of chance software 160 can be used by a server (e.g., the server 140) to operate or execute the online game(s) of chance. Moreover, the game of chance software 160 can be used by a computing device (e.g., the participant device 120) to receive information associated with, and participate in, the online game(s) of chance.

The game of chance software 160 can include tools, such as programs, subprograms, functions, routines, subroutines, operations, executable instructions, and/or the like for, inter alia and as further described below, execute or operate the online game(s) of chance, and/or participate in the online game(s) of chance.

At least some of the game of chance software 160 can be implemented as respective software programs that can be executed by the server 140, the participant device 120, and/or combinations thereof. A software program can include machine-readable instructions that can be stored in a memory (such as a memory of the server 140 and/or a memory of the participant device 120), and that, when executed by a processor (such as a processor of the server 140 and/or a processor of the participant device 120), cause the server 140 and/or the participant device 120 to perform the instructions of the software program. As shown, the game of chance software 160 can include at least a profile creation tool 162, a purchase receiving tool 164, a participant scheduler tool 166, a randomizer and winner determination tool 168, a participant and prize determination tool 170, a prize and charity distribution automation tool 172, and/or a notification tool 174. In some implementations, the game of chance software 160 can include more or fewer tools. In some implementations, some of the tools can be combined, some of the tools can be split into more tools, or a combination thereof.

For example, the profile creation tool 162 can be used to create participant profiles, such as the participant profile 141.

For example, the purchase receiving tool 164 can be used to receive purchases from the participant device 120. For example, such purchases can correspond to a ticket purchase or purchase of a chance for winning a prize for the online game(s) of chance (e.g., the Hex perpetual game). For example, such purchases can be made through credit card of the participants, other online payment method, or method of transferring money online. For example, tickets that are purchased by the participants can be used to participate in the online game(s) of chance. For example, the tickets do not have to be used immediately, but can be stored under the participant profile and can be used later. In some implementations, the tickets can have expiration date for usage.

For example, the participant scheduler tool 166 can be used to schedule game participation based on participant preference. For example, the participant scheduler tool 166 can receive the participant preference from the participant device 120 or the server 140. For example, the participant preference can include indication of when the participant wants to participate in the online game(s) of chance. For example, the participant preference can include a subscription option and a custom option.

With regards to the subscription option, for example, the participant can subscribe or configure participation time to happen periodically. For example, the participant can configure or order to use a certain number of tickets to participate for one or more of the online game(s) of chance periodically. For example, the participant can configure or order to use two tickets to participate in the day game (of the Hex perpetual game) every Monday. For example, the participant can configure or order to use one ticket to participate in the day game every 20^{th} of each month. For example, the participant can configure or order to use three tickets to participate in the minute game every day until a certain end date.

With regards to the custom option, the participant can configure or order to use a certain number of tickets to participate for one or more of the online game(s) of chance at a specific date and/or time. For example, the participant can configure or order to use one ticket to participate in the day game on his or her birthday. For example, in some implementations, given the nature of the Hex perpetual game being played continuously based on timing, participant can choose (e.g., configure or order) to participate in the minute gate, the hour game, and/or the day game and see the result of the draw (e.g., whether or not the participant has won any prize) simultaneously on that same day. For example, assuming that a current date for the participant is May 1, 2023, and the participant chose to participate in the hour game with one ticket on his or her wedding anniversary date, e.g., Aug. 8, 2023, then the participant can both participate and see the result of the draw for the hour game on that very day of his or her wedding anniversary date. In some implementations, participant can have option of displaying a current time (e.g., time contemporaneous to the participant time zone, local time zone) instead of the standardized time. For example, in such scenario, the game of chance software 160 can automatically convert the standardized time (e.g., Greenwich mean time, default time) to the current time based on a global positioning system (GPS) or a location sensor of the participant device 120. For example, when the participant chooses option to convert and/or display the current time and the participates using the custom option (e.g., at specific chosen date), then at least for the minute game and the hour game, it can be guaranteed that the participant can participate in the game and see the result of the draw on that same day (of the specific chosen date) based on the custom option.

For example, the randomizer and winner determination tool 168 can be used to randomize drawings or participant tickets used for the drawings. For example, after or at the end of each cycle, the randomizer and winner determination tool 168 can initiate automatic drawing (e.g., prize drawing) process based randomized drawing method, which would pick at least one winner participant for each cycle for each game. Moreover, there can be multiple winners for each cycle for each game, as described above with respect to FIG. 1A.

For example, the participant and prize determination tool 170 can be used to determine a past and real-time statistical data of frequency of participant, prize, and/or prize winner. For example, the participant and prize determination tool 170 can be used to determine the participant and prize data 144, which includes the historical data 146 and the real-time data 145 associated with how many participants have participated in each cycle of each game in history and in real-time, and corresponding history of and real-time prize data. Moreover, for example, the participant and prize determination tool 170 can be used to determine a past and real-time statistical data of frequency of participant, prize, and/or prize winner based on geographical region that the participant is located in and/or geographical information of local regions, countries, and/or continents. Once determined, such historical data 146 and real-time data 145 can be output (e.g., to the participant device 120) for display on the map based on the geographical information and/or within certain distance or radius of real-time location of the participant device 120.

For example, the prize and charity distribution automation tool 172 can be used to distribute a certain portion of the total prize(s) as the prize(s) to prize winners (among the participants), and a certain portion of prize, and/or another portion of the total prize(s) as donations to one or more assigned charities (e.g., based on the charity data 148). For example, as described above, a first portion of the total prize(s) can be distributed to the prize winners, a second portion of the total prize(s) can be distributed to an operator (e.g., company or entity that operates the online game(s) of chance) as operational cost, a third portion of the total prize(s) can be distributed to the operator as profits, and/or a fourth portion of the total prize(s) can be distributed to one or more assigned charities. The prize(s) and charity distribution automation tool 172 can also make a distribution to the one or more assigned charities on behalf of the operator.

For example, the notification tool 174 can be used to output one or more notifications to the participant device 120. For example, the one or more notifications can include notifications associated with the historical data 146 and/or the real-time data 145. For example, after or responsive to determining the real-time participation level and the monetary value of the prize (of the ongoing game), the notification tool 174 can output a notification that indicates the real-time participation level, and/or the monetary value of the prize on the display of the participant device. For example, after or responsive to determining the past participation level and the past monetary value of the prize, the notification tool 174 can output a notification that indicates the past (e.g., historical) participation level, and/or the past monetary value of the display of the participant device 120. For example, after or responsive to determining the past participation level, the real-time participation level, the past monetary value of the prize, and/or the real-time monetary value of the prize, the notification tool 174 can output any combination of the past participation level, the real-time participation level, the past monetary value of the prize, and/or the real-time monetary value of the prize. In some implementations, the past participation level, the real-time participation level, the past monetary value of the prize, and/or the real-time monetary value of the prize can be based on the geographical region that the participant is located in, as described above.

Moreover, the one or more notifications can include notifications that are not necessarily associated with the historical data 146 and/or the real-time data 145. For example, after or responsive to determining that a participant did not win at least one of the prizes, the notification tool 174 can output notification on the display of the participant device, in which the notification indicates the participant to participate in a next game that occurs in a next respective cycle of the respective game.

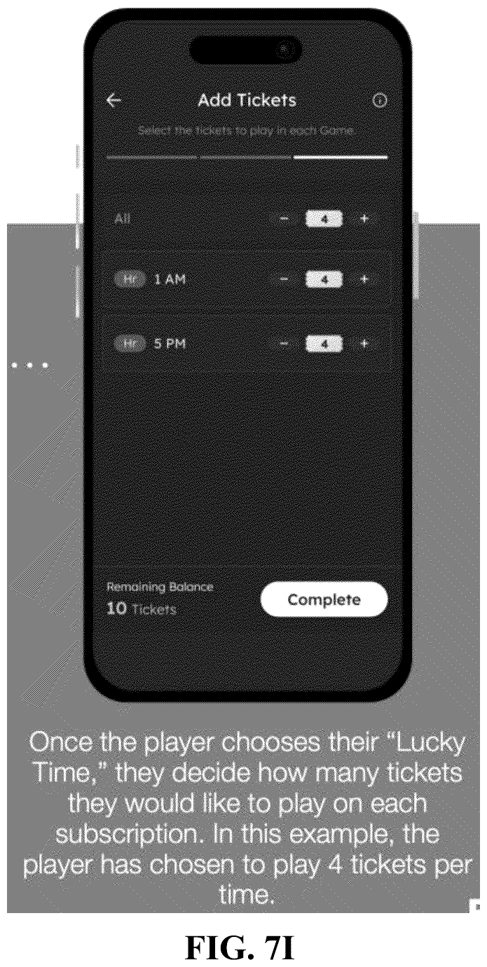

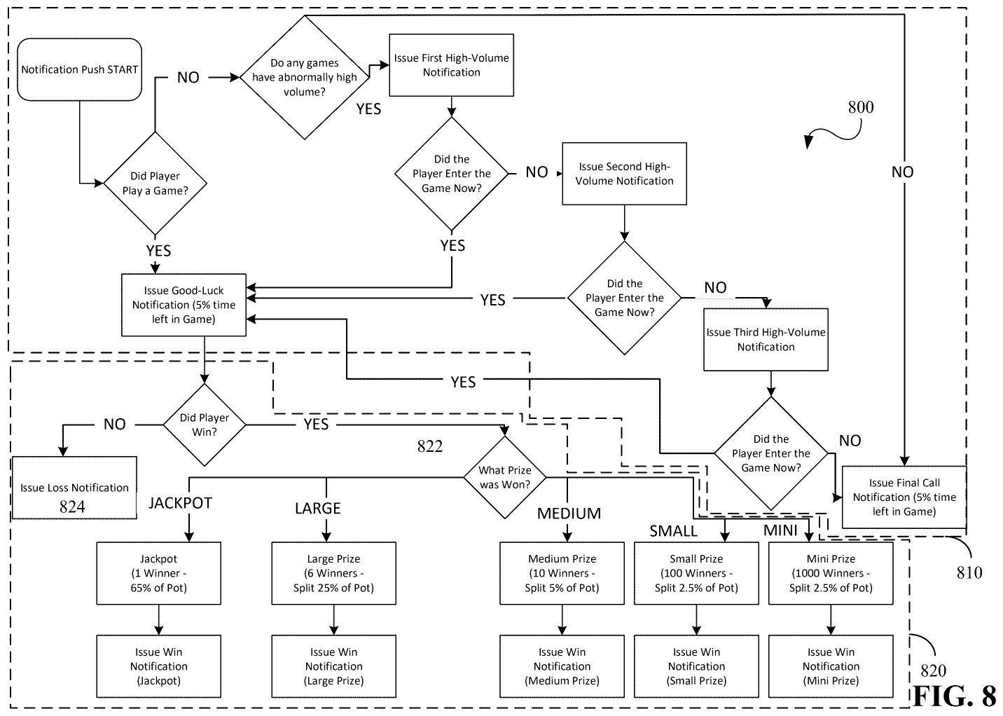

For example, the one or more notifications can include any of the notifications that are depicted in FIG. 8.

FIG. 2 depicts an illustrative processor-based, computing device 200. The computing device 200 can implement operating and/or participating in the online game(s) of chance, run an application or software (e.g., the game of chance software 160) related to operating and/or participating in the online game(s) of chance. The computing device 200 can be representative of the type of computing device that can be present in or used in conjunction with at least some aspects of the participant device 120 and/or the server 140 of FIG. 1B and/or other devices at least partially implementing functionality or techniques described with respect to the system 100 of FIG. 1B, or any other device that includes electronic circuitry. The computing device 200 is illustrative only and does not exclude the possibility of another processor-or controller-based system being used in or with any of the aforementioned aspects of the participant device 120 and/or the server 140.

In one aspect, the computing device 200 can include one or more hardware and/or software components configured to execute software programs, such as software for obtaining, storing, processing, and analyzing signals, data, or both. For example, the computing device 200 can include one or more hardware components such as, for example, a processor 205, a random-access memory (RAM) 210, a read-only memory (ROM) 220, a storage 230, a database 240, one or more input/output (I/O) modules 250, and an interface 260. Alternatively, and/or additionally, the computing device 200 can include one or more software components such as, for example, a computer-readable medium including computer-executable instructions for performing techniques or implement functions of tools consistent for automating prior authorizations. It is contemplated that one or more of the hardware components listed above can be implemented using software. For example, the storage 230 can include a software partition associated with one or more other hardware components of the computing device 200. The computing device 200 can include additional, fewer, and/or different components than those listed above. It is understood that the components listed above are illustrative only and not intended to be limiting or exclude suitable alternatives or additional components.

The processor 205 can include one or more processors, each configured to execute instructions and process data to perform one or more functions associated with the computing device 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2, the processor 205 can be communicatively coupled to the RAM 210, the ROM 220, the storage 230, the database 240, the I/O module 250, and the interface 260. The processor 205 can be configured to execute sequences of computer program instructions to perform various processes (e.g., techniques), such as those described herein for automating prior authorizations. The computer program instructions can be loaded into the RAM 210 for execution by the processor 205.

The RAM 210 and the ROM 220 can each include one or more devices for storing information associated with an operation of the computing device 200 and/or the processor 205. For example, the ROM 220 can include a memory device configured to access and store information associated with the computing device 200, including information for identifying, initializing, and monitoring the operation of one or more components and subsystems of the computing device 200. The RAM 210 can include a memory device for storing data associated with one or more operations of the processor 205. For example, the ROM 220 can load instructions into the RAM 210 for execution by the processor 205.

The storage 230 can include any type of storage device configured to store information that the processor 205 can use to perform processes consistent with the disclosed implementations. The database 240 can include one or more software and/or hardware components that cooperate to store, organize, sort, filter, and/or arrange data used by the computing device 200 and/or the processor 205. For example, the database 240 can include end-user profile information, historical activity and end-user specific information, predetermined menu/display options, and other end-user related data. Alternatively, the database 240 can store additional and/or different information. The database 240 can be used to store admin data, patient data, order-related data, authorization-related data and/or other data used or generated in accordance with implementations of this disclosure.

The I/O module 250 can include one or more components configured to communicate information with a user associated with the computing device 200. For example, the I/O module 250 can comprise one or more buttons, switches, or touchscreens to allow a user to input parameters associated with the computing device 200. The I/O module 250 can also include a display including a graphical user interface (GUI) and/or one or more light sources for outputting information to the user. The I/O module 250 can also include one or more communication channels for connecting the computing device 200 to one or more secondary or peripheral devices such as, for example, a desktop computer, a laptop, a tablet, a smart phone, a flash drive, or a printer, to allow a user to input data to or output data from the computing device 200.

The Interface 260 can include one or more components configured to transmit and receive data via a communication network, such as the Internet, a local area network, a workstation peer-to-peer network, a direct link network, a wireless network, or any other suitable communication channel. For example, the interface 260 can include one or more modulators, demodulators, multiplexers, demultiplexers, network communication devices, wireless devices, antennas, modems, and any other type of device configured to enable data communication via a communication network.

FIG. 3 is a flowchart of an example of a technique 300 for executing online games of chance, such as Hex-Perpetual games. The technique 300 can be implemented by a server (e.g., the server 140), the computing device 200, a Hex-Perpetual engine, and/or another processing-based device. Further, the technique 300 can implement, be implemented by, or in conjunction with the implementations described above with respect to FIGS. 1-2.

At 302, purchases of tickets for the online game(s) of chance are received. For example, tickets to participate in the Hex-Perpetual games (including the minute game, the hour game, the day game, the month game, and/or the year game) can be received. For example, such ticket purchases can be received by the server (such as the server 140 described above with respect to the system 100 of FIG. 1B). For example, the tickets can be manually or automatically used toward participating in one or more of the Hex-Perpetual games.

For example, as described above with respect to FIGS. 1A and 1B, the online game of chance can include at least two independent games (e.g., the hour game, the day game), which have game durations that simulate the timing system, the calendar time, and/or the standardized time. For example, each game can be played continuously for multiple cycles (e.g., multiple rounds) with each cycle (e.g., round) having a respective time duration (e.g., game duration).

For example, as described above, the minute game can have a duration of (e.g., played for) a minute, the hour game can have a duration of an hour, the day game can have a duration of a day, and the year game can have a duration of a year. For example, participants can participate (e.g., act of entering or applying for a specific drawing or round of a lottery) in a draw (e.g., prize draw) or play the game of chance or lottery by buying one or more tickets. For example, participants can have a minute to enter a cycle (e.g., a round) of the minute game, an hour to enter a cycle of the hour game, a day to enter a cycle of the day game, a week to enter a cycle of the week game, a month to enter a cycle of the month game, and a year to enter a cycle of the year game.

For example, the standardized time can be used for each cycle of each game such that participants across different regions or different countries can see and participate at a same start time and a same end time for each cycle of a respective game.

For example, at least one or more cycles of one game (e.g., the minute game) can overlap in time (e.g., play time, time allowed to participate in a draw) with at least one cycle of the other game (e.g., the hour game).

At 304, randomized drawing is initiated. For example, the drawing can be a randomized process or randomized drawing for winning the prizes for the online game(s) of chance. For example, after or at the end of each cycle of each game, there can be automatic drawing (e.g., prize drawing) process based on randomized drawing method, which would select at least one winner participant for each cycle for each game. For example, such randomized drawing can be initiated by the server.

At 306, at least one prize winner for each cycle of each game can be selected. For example, based on the randomized drawing, at least one prize winner for each cycle of each game can be selected by the server.

Moreover, there can be multiple winners for each cycle for each game. For example, there can be five winners for each cycle for each game, with a first prize winner collecting a first largest portion of a total prize(s) (e.g., pot, total amount of money that can be won), a second prize winner collecting a second largest portion of the pot, a third prize winner collecting a third largest portion of the of the pot, a fourth prize winner collecting a fourth largest portion of the pot, and a fifth prize winner collecting a fifth largest portion of the pot. In some implementations, there can be more or less than five winners for each cycle for each game. In implementations, the first prize winner can be a jackpot winner, the second prize winner can be a large prize winner, the third prize winner can be a medium prize winner, the fourth prize winner can a small prize winner, and a fifth prize winner can be a mini prize winner as described herein with respect to FIG. 8.

Once one or more winners are selected, prize(s) are distributed to the one or more winners. For example, the one or more winners can be first notified via email or to a participant device (e.g., the participant device 120) through participant account on software or platform (e.g., the game of chance software 160 running on the participant device 120). For example, before the prize(s) are paid out, the lottery organization can verify identity of the one or more winners, inform the one or more winners of tax obligations and/or requirements, notify the one or more winners of the payment options. Depending on amount of money or prize(s) to be paid out, different payment options (e.g., bank transfer, check shipment, direct deposit, prepaid debit card, annuity payment, escrow account, electronic wallet, cryptocurrency, etc.) can be used. The payment options can include preferred payment option selected by the participants or associated with participant profile.

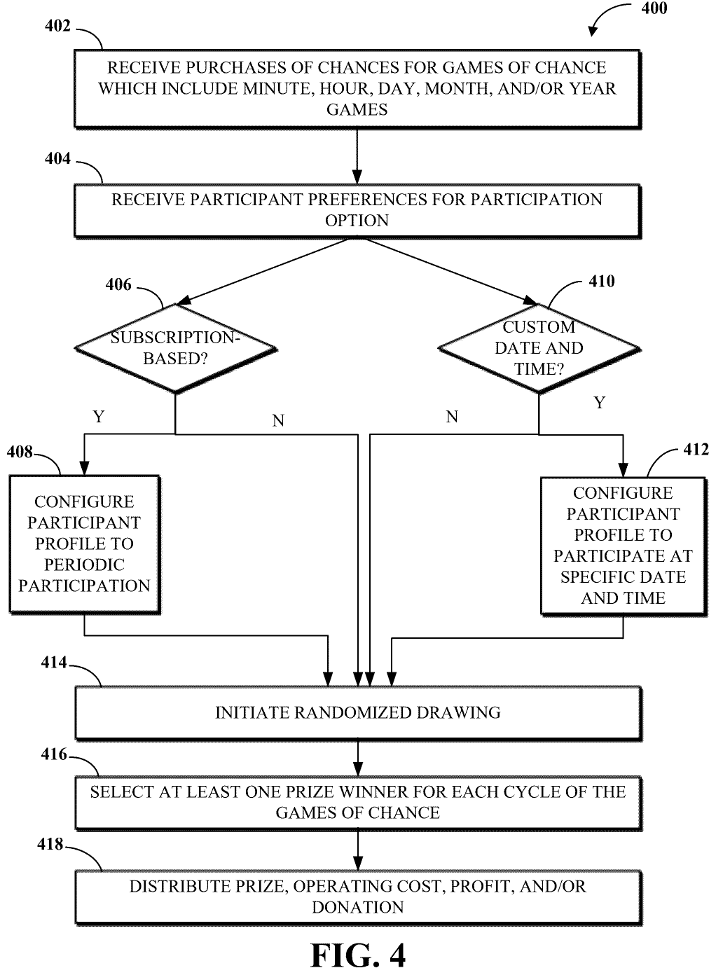

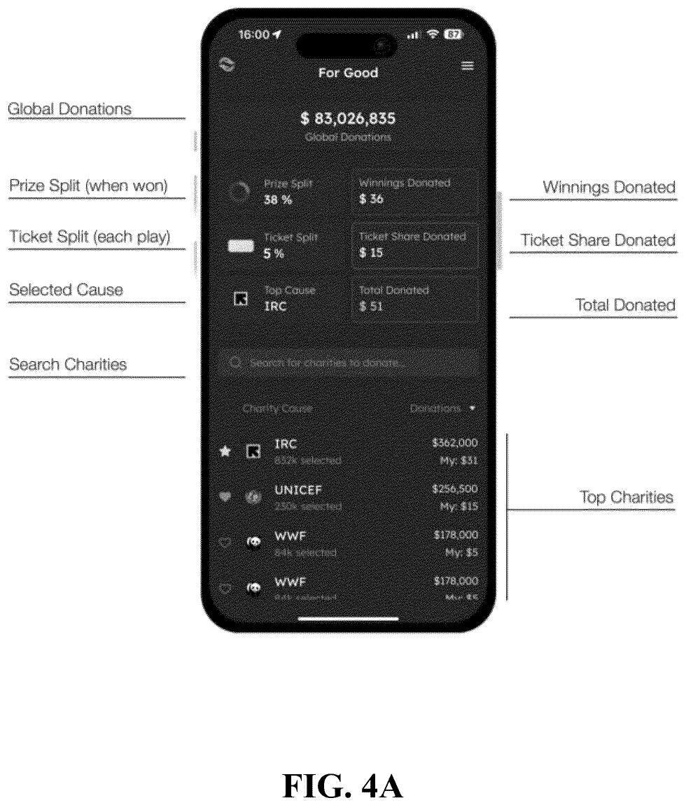

FIG. 4 is a flowchart of an example of a technique 400 for subscribing and/or configuring participation time and executing an online game of chance. The technique 400 can be implemented by a server (e.g., the server 140), the participant device 120, the computing device 200, and/or another processing-based device. Further, the technique 400 can implement, be implemented by, or in conjunction with the implementations described above with respect to FIGS. 1-3.

At 402, purchases of chances for the online game(s) of chance are received. Since such purchases can be made in the same manner as described with respect to step 302 of the technique 300, this step is not repeated here.

At 404, participant preferences for participation option are received. For example, participants can participate or enter the draw periodically through subscription option or participate or enter the draw at a certain date of participant preference by utilizing custom date participation option. For example, such participant preferences for participation option can be received by the server.

As described above with respect to FIG. 1B, with regards to the subscription option, for example, participant can subscribe or configure participation time to happen periodically. For example, the participant can configure or order to use a certain number of tickets to participate for one or more of the online game(s) of chance periodically. For example, the participant can configure or order to use two tickets to participate in the day game (of the Hex perpetual game) every Monday. For example, the participant can configure or order to use one ticket to participate in the day game every 20^{th} of each month. For example, the participant can configure or order to use three tickets to participate in a minute game every day until a certain end date.

With regards to the custom option, the participant can configure or order to use a certain number of tickets to participate for one or more of the online game(s) of chance at a specific date and/or time. For example, the participant can configure or order to use one ticket to participate in the day game on his or her birthday. For example, in some implementations, given the nature of the Hex perpetual game being played continuously based on timing, participant can choose (e.g., configure or order) to participate in the minute gate, the hour game, and/or the day game and see the result of the draw (e.g., whether or not the participant has won any prize) simultaneously on that same day. For example, assuming that a current date for the participant is May 1, 2023, and the participant chose to participate in the hour game with one ticket on his or her wedding anniversary date, e.g., Aug. 8, 2023, then the participant can both participate and see the result of the draw for the hour game on that very day of his or her wedding anniversary date. In some implementations, participant can have the option of displaying a current time (e.g., time contemporaneous to the participant time zone, local time zone) instead of the standardized time. For example, in such scenario, a software such as the game of chance software 160 can automatically convert the standardized time (e.g., Greenwich mean time, default time) to the current time based on a global positioning system (GPS) or a location sensor of a participant device (such as the participant device 120). For example, when the participant chooses option to convert and/or display the current time and the participates using the custom option (e.g., at specific chosen date), then at least for the minute game and the hour game, it can be guaranteed that the participant can participate in the game and see the result of the draw on that same day (of the specific chosen date) based on the custom option.

For example, at 406 and at 410, whether the participant preference indicates the subscription-based option or the custom option is determined. If the participant preference indicates the subscription-based option, then at 408, participant profile is configured to periodic participation such that the participant account is configured to participate in the game automatically and periodically at certain frequency and/or certain dates. If the participant preference indicates the custom option, then at 412, the participant profile is configured to automatically participate at specific date and/or time.

If the participant does not have any preference, then the participant account participates in the game specified by the participant.

At 414, randomized drawing is initiated. Since such drawing technique can be implemented in the same manner as described with respect to step 304 of the technique 300, this step is not repeated here.

At 416, at least one prize winner for each cycle of each game can be selected. For example, based on the randomized drawing, at least one prize winner for each cycle of each game can be selected. Since such distribution can be implemented in the same manner as described with respect to step 306 of the technique 300, this step is not repeated here.

As described above with respect to the step 306, there can be multiple winners for each cycle for each game.

At 418, once one or more winners are selected, prize(s), operating cost, profit, and/or donation can be distributed.

For example, prize(s) can be distributed to the one or more winners. For example, the server can notify the one or more winners via email or to a participant device (e.g., the participant device 120) through participant account on software or platform (e.g., the game of chance software 160 running on the participant device 120). For example, before the prize(s) are paid out, the lottery organization can verify identity of the one or more winners, inform the one or more winners of tax obligations and/or requirements, notify the one or more winners of the payment options. Depending on amount of money or prize(s) to be paid out, different payment options (e.g., bank transfer, check shipment, direct deposit, prepaid debit card, annuity payment, escrow account, electronic wallet, cryptocurrency, etc.) can be used. The payment options can include preferred payment option selected by the participants or associated with participant profile.

Moreover, as described above with respect to FIG. 1B, a first portion of total prize(s) can be distributed as prize(s) to prize winners (among the participants), a second portion of the total prize(s) can be distributed as donations to one or more assigned charities (e.g., based on the charity data 148). Additionally for example, a certain portion of the total prize(s) can be distributed to an operator (e.g., company or entity that operates the online game(s) of chance) as operational cost, and another portion of the total prize(s) can be distributed to the operator as profits. FIG. 4A is an example of a charitable giving or donation page or screen.

Moreover, with respect to donations to the one or more charities, there are two donation distributions. As noted, a portion of the prize distributed to the winners is distributed to one or more charities designated by the prize winners. In addition, the operator also makes a charitable donation to the one or more charities designated by the prize winners.

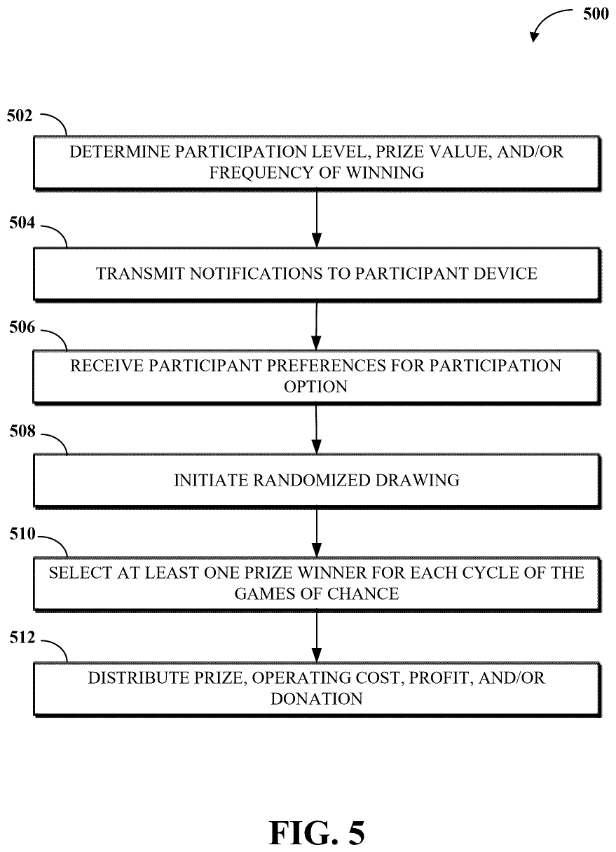

FIG. 5 is a flowchart of an example of a technique 500 for transmitting notification associated with historic and/or real-time online game of chance data. The technique 500 can be implemented by a server (e.g., the server 140), the computing device 200, a Hex-Perpetual engine, and/or another processing-based device. Further, the technique 500 can implement, be implemented by, or in conjunction with the implementations described above with respect to FIGS. 1-4.

At 502, data associated with participation level, prize value, and/or frequency of winning are determined. For example, such data can include a past and real-time statistical data of frequency of participant, prize, and/or prize winner. For example, historical data (e.g., the historical data (146) and real-time data (e.g., the real-time data 145) associated with how many participants have participated in each cycle of each game in history and in real-time, and corresponding history of and real-time prize data can be determined. Moreover, for example, past and real-time statistical data of frequency of participant, prize, and/or prize winner based on geographical region that the participant is located in and/or geographical information of local regions, countries, and/or continents can be determined. For example, such data can be determined by the server.

At 504, notifications with regards to such data associated with participation level, prize value, and/or frequency of winning are transmitted to the participant device. For example, such data can be output to a participant device (e.g., the participant device 120) for display at user interface. For example, such data can be output to the participant device on a map based on the geographical information and/or within certain distance or radius of real-time location of the participant device (in which the real-time location can be determined by the GPS of the participant device). For example, such notifications can be transmitted by the server to the participant device.

For example, after or responsive to determining a historical frequency of winning at least one of the prizes based on the geographical regions, the historical frequency can be output on a display of the participant device.

For example, after or responsive to determining the real-time participation level and the monetary value of the prize, notification (that indicates the historical participation level, the real-time participation level, and/or the monetary value of the prize) can be transmitted to and/or output on the display of the participant device.

For example, after or responsive to determining the real-time participation level and the monetary value of the prize, notification (that indicates the historical frequency, the real-time participation level, and/or the monetary value of the prize) can be transmitted to and/or output on the display of the participant device.

At 506, participant preferences for participation option are received. Since such participant preferences can be received in the same manner as described with respect to step 404 of the technique 400, this step is not repeated here.

At 508, randomized drawing is initiated. Since such drawing technique can be implemented in the same manner as described with respect to step 304 of the technique 300, this step is not repeated here.

At 510, at least one prize winner for each cycle of each game can be selected. For example, based on the randomized drawing, at least one prize winner for each cycle of each game can be selected.

As described above with respect to the step 306, there can be multiple winners for each cycle for each game.

At 512, once one or more winners are selected, prize(s), operating cost, profit, and/or player and/or organization donation can be distributed. Since such distribution steps or technique can be the same with respect to step 418, this step is not repeated here.

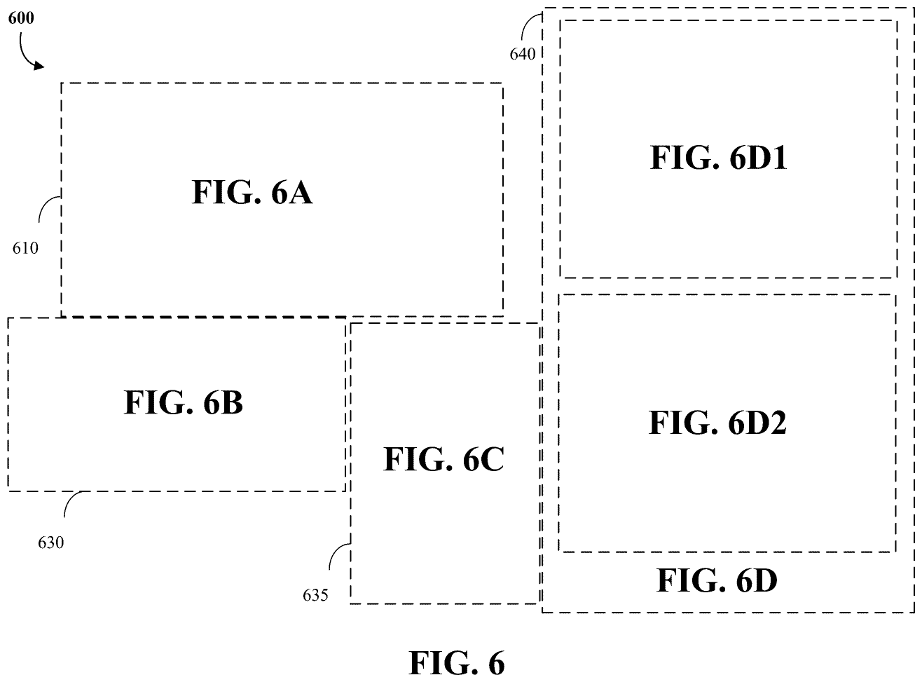

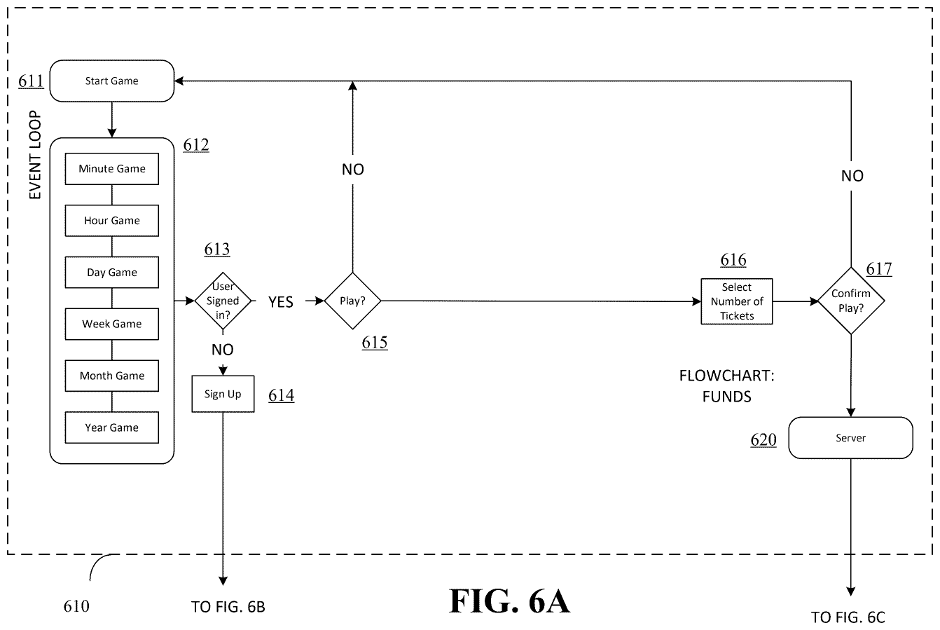

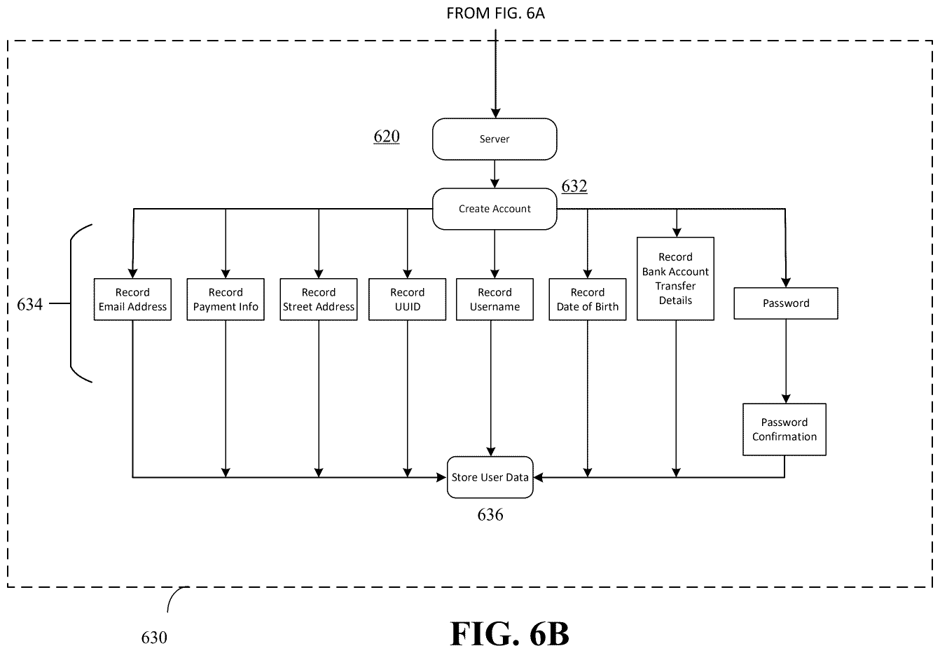

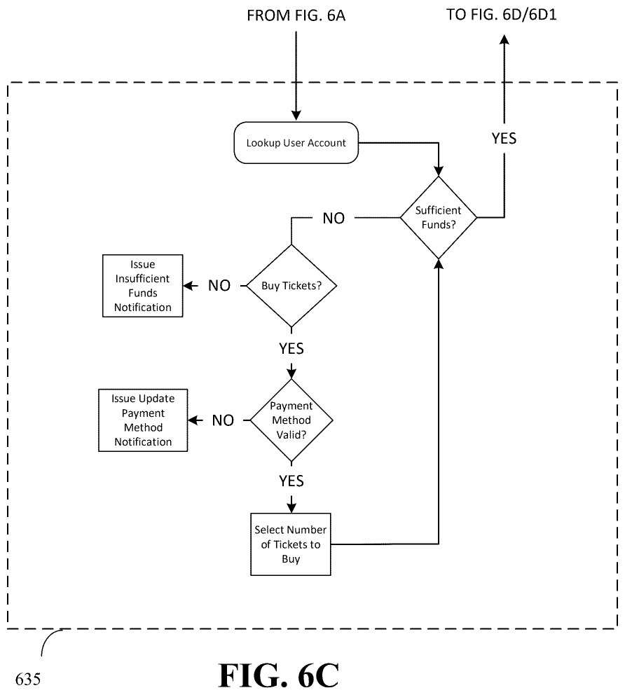

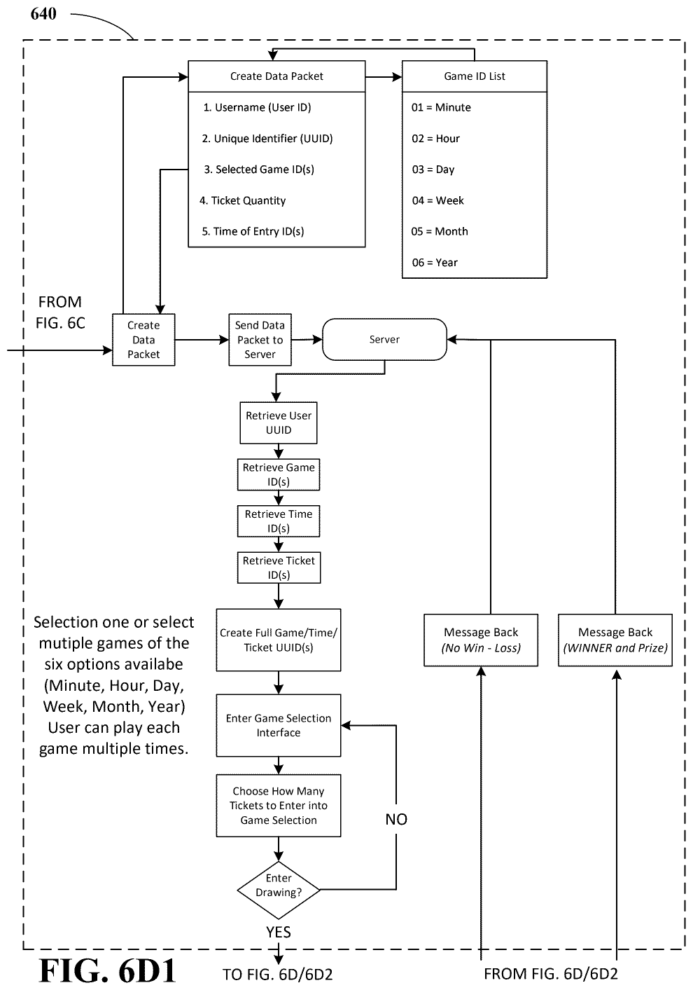

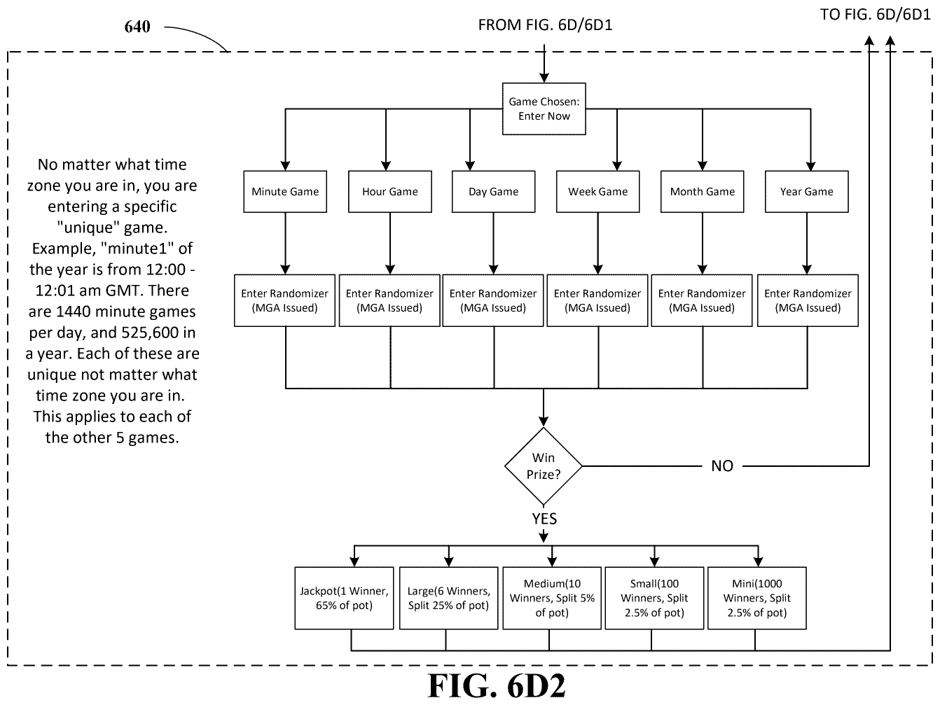

FIGS. 6 and 6A-6D2 are flowcharts of an example of a technique 600 for executing an online game of chance. FIGS. 6 and 6A-6D2 are inter-connected flowcharts, where FIG. 6 shows the interconnections between the FIGS. 6A-6D2. Implementations illustrated in FIGS. 6 and 6A-6D2 can be implemented by a server (e.g., the server 140), the computing device 200, the participant device 120, a Hex-Perpetual engine, and/or another processing-based device. Further, implementations illustrated in FIGS. 6 and 6A-6D2 can implement, be implemented by, or in conjunction with the implementations described above with respect to FIGS. 1-5.

The technique 600 can include at least a user input processing portion 610 associated with initiation of the game, profile creation, and/or combinations thereof as described herein. At 611, a user or participant can, via a user interface on a participant device such as interface 260 on the participant device 120, start the application and/or software. At 612, the user can select one or more games. At 613, the application and/or software on the participant device and/or a server 620 can determine whether the user has signed in. If the user is a new user, then the application initiates a sign up processing portion 614. The sign up processing portion 614 executes a profile creation processing portion 630 as described herein. The profile creation processing portion 630, via the server 620, creates an account 632, gathers information 634, and stores the user data 636. If the user has signed in, at 615, the application determines whether the user wants to play. If the user does not want to play or is not ready to play, the application returns to start game 611. If the user wants to play, at 616, the user enters the number of tickets to be used. At 617, play confirmation can be requested. If play is not confirmed, the application returns to start game 611. If play is confirmed, the application initiates tickets and/or funds verification processing portion 635. The tickets and/or funds verification processing portion 635 can look up the user account and determine if sufficient tickets are available and/or if sufficient funds are available to buy tickets. If there are not a sufficient number of tickets, then the application and/or user can attempt to buy more tickets. If sufficient funds are not available, then an alert is sent. If sufficient funds are available, then payment method can be verified. An alert can be sent if payment method needs to be updated. If the payment method is valid, then tickets are purchased and processing returns to determine if sufficient tickets are now available.

If there are sufficient tickets available, then a game processing portion 640 can be initiated. The game processing portion 640 can generate and process a data packet based on the user selection inputs, for example, the selected number of tickets, which games, how many ticket for each game and other game variables. As described herein, the game processing portion 640 can execute the drawing processing including, for example, randomizing, drawing winner(s), and determining prizes if winners are selected.

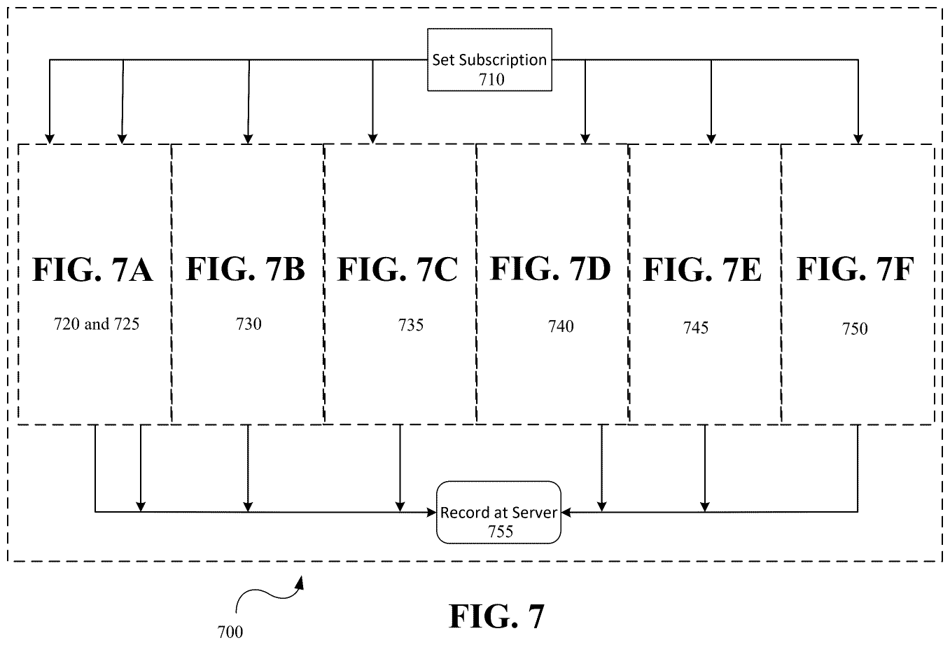

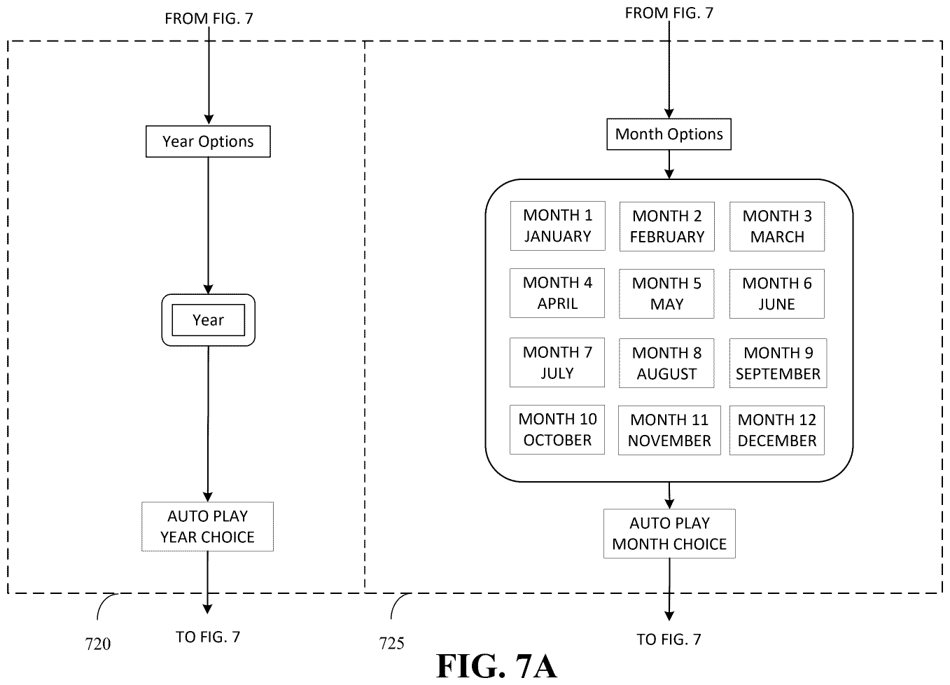

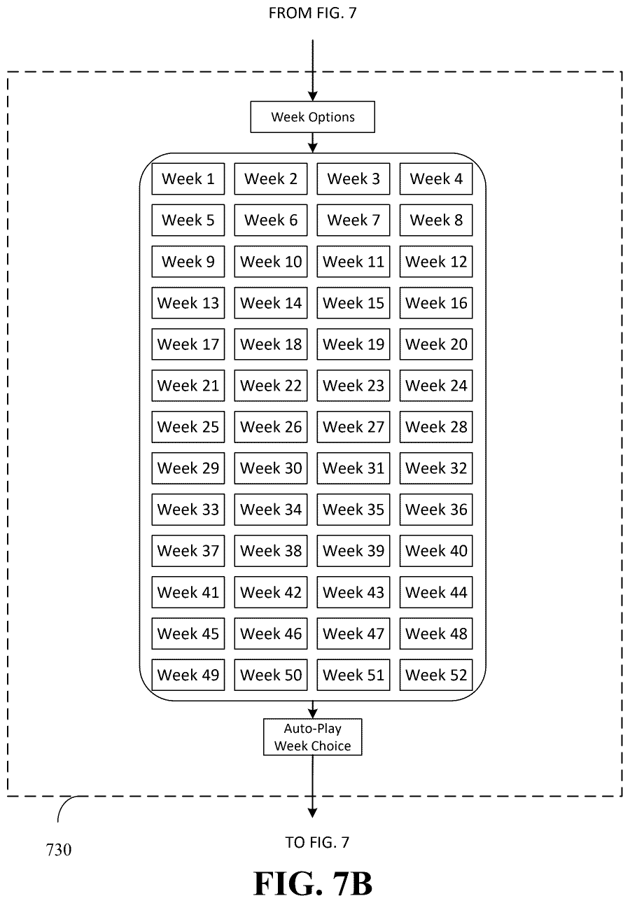

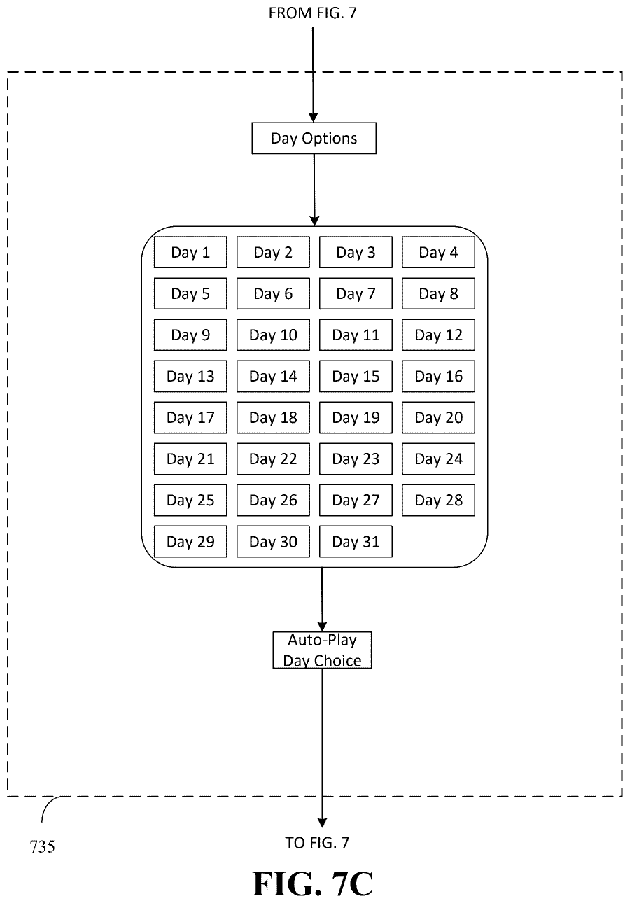

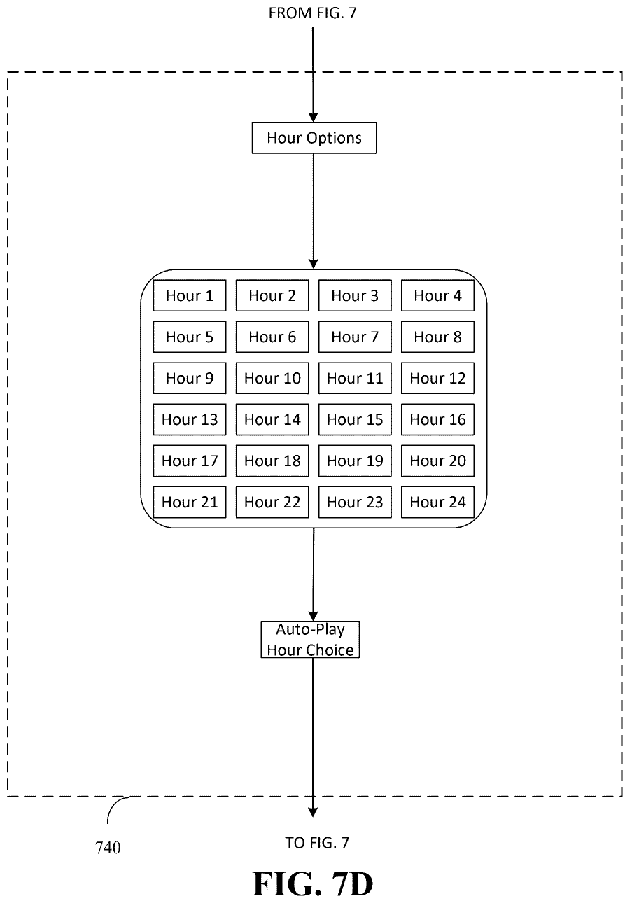

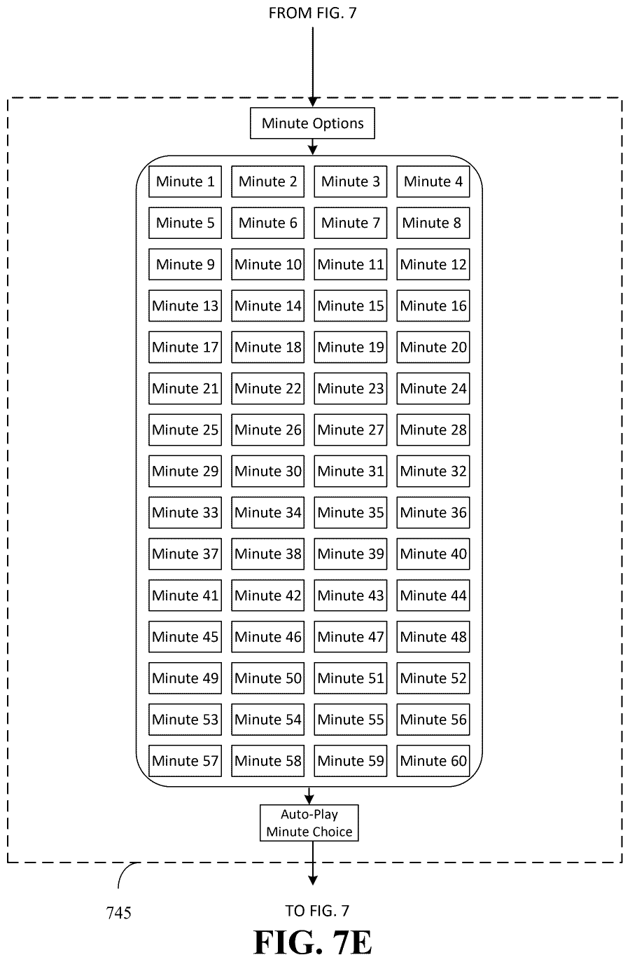

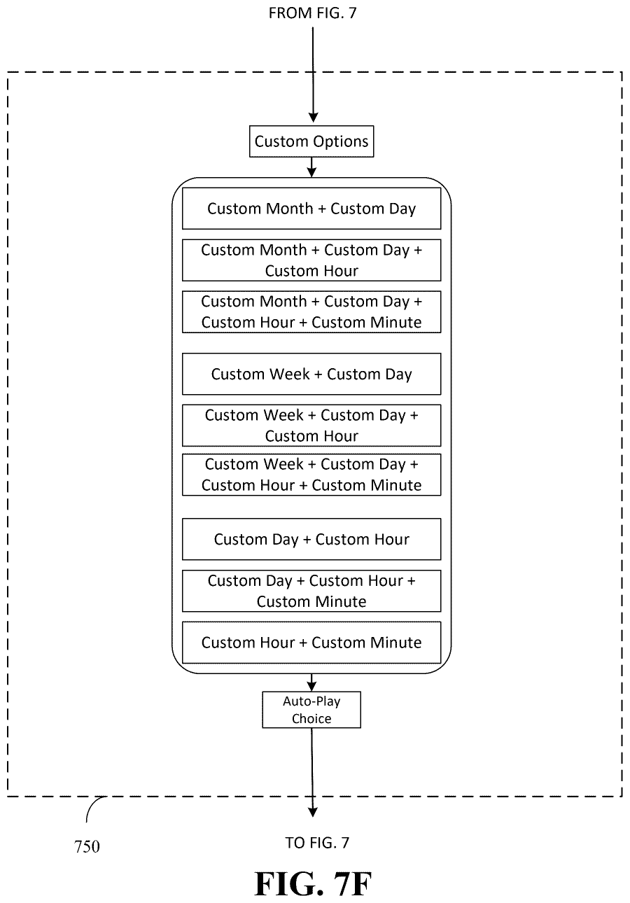

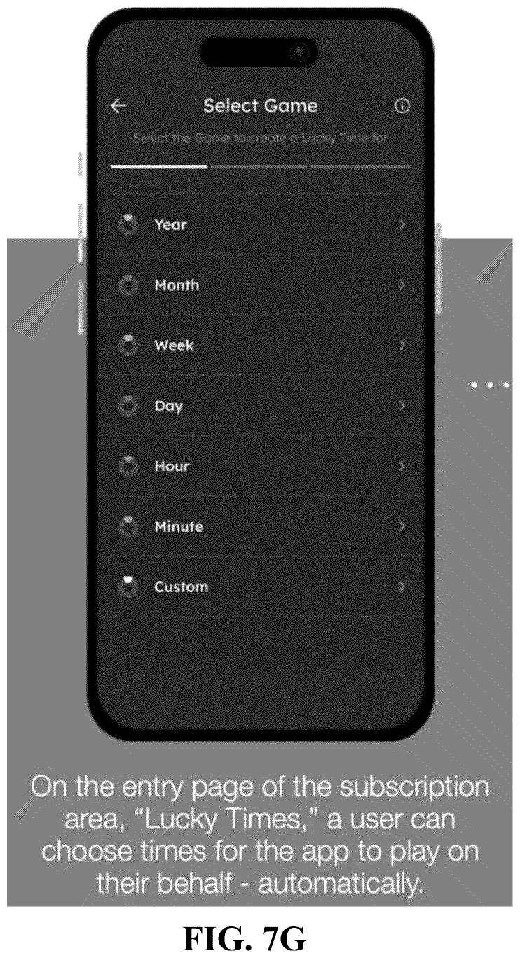

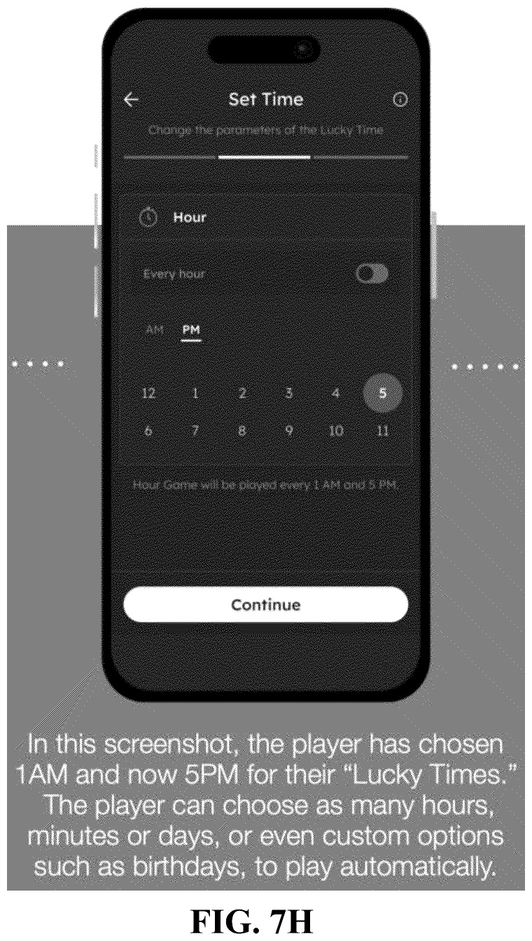

FIGS. 7 and 7A-7F are flowcharts of an example of a technique 700 for subscribing and/or configuring participation time and executing an online game of chance. FIGS. 7 and 7A-7F are inter-connected flowcharts, where FIG. 7 shows the interconnections between the FIGS. 7A-7F. Implementations illustrated in 7 and 7A-7F can be implemented by a server (e.g., the server 140), the computing device 200, the participant device 120, a Hex-Perpetual engine, and/or another processing-based device. Further, implementations illustrated in 7 and 7A-7F can implement, be implemented by, or in conjunction with the implementations described above with respect to FIGS. 1-6D2. The technique 700 includes enabling a user to input and/or configure various subscription options 710 including year options 720 as shown in FIG. 7A, month options 725 as shown in FIG. 7A, week options 730 as shown in FIG. 7B, day options 735 as shown in FIG. 7C, hour options 740 as shown in FIG. 7D, minute options 745 as shown in FIG. 7E, custom options 750 as shown in FIG. 7F, and/or combinations thereof. The entered options can be stored 755 appropriately. An example of subscribing and/or configuring participation time pages or screens are shown in FIGS. 7G-I.

FIG. 8 is a flowchart of an example of a technique 800 for transmitting notifications associated with execution of an online game of chance. Implementations illustrated in FIG. 8 can be implemented by a server (e.g., the server 140), the computing device 200, the participant device 120, a Hex-Perpetual engine, and/or another processing-based device. Further, implementations illustrated in FIG. 8 can implement, be implemented by, or in conjunction with the implementations described above with respect to FIGS. 1-7F. The technique 800, for example, can determine if a particular game has a high volume or significant user participation such that a prize portion can be greater than a historically average prize (810). One or more alerts can be sent to one or more users in the event of high volume or significant user participation in a game. Notification of winners 822, non-winners 824, and/or combinations thereof can be sent to one or more user(s) (820). The winners 822 can include a jackpot winner, a large prize winner, a medium prize winner, a small prize winner, and/or a mini prize winner.

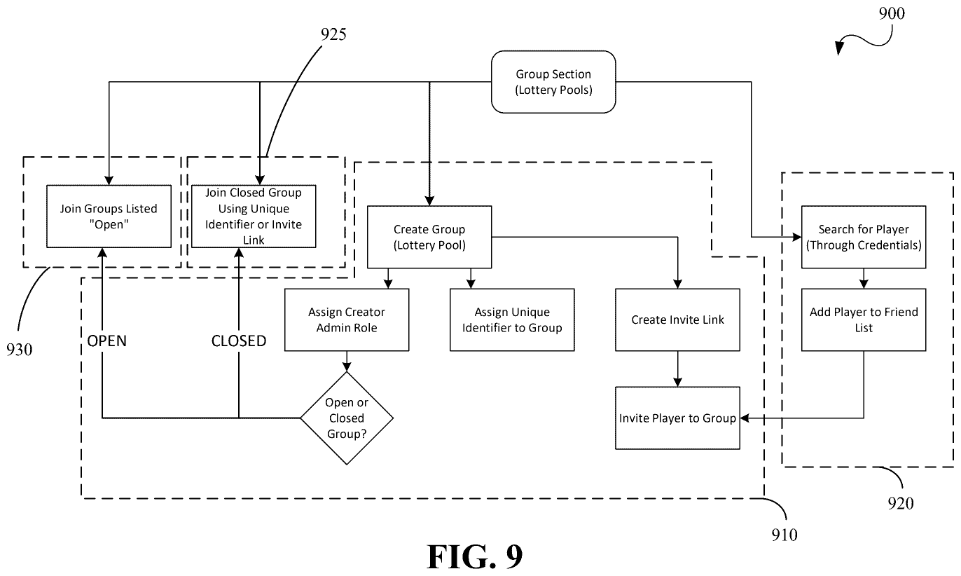

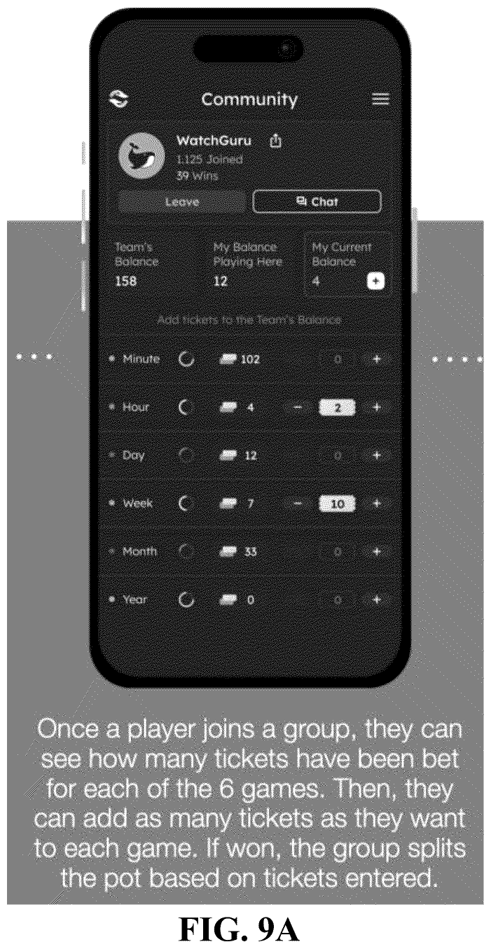

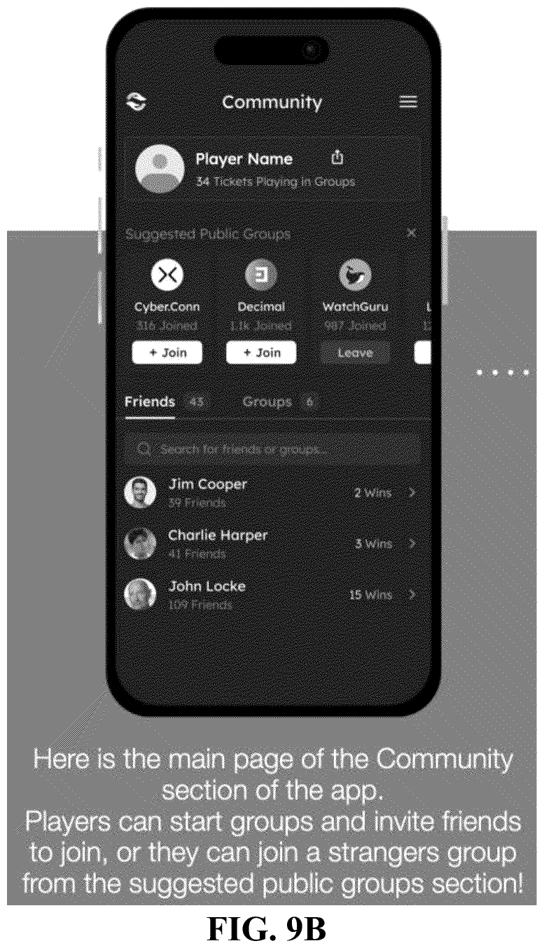

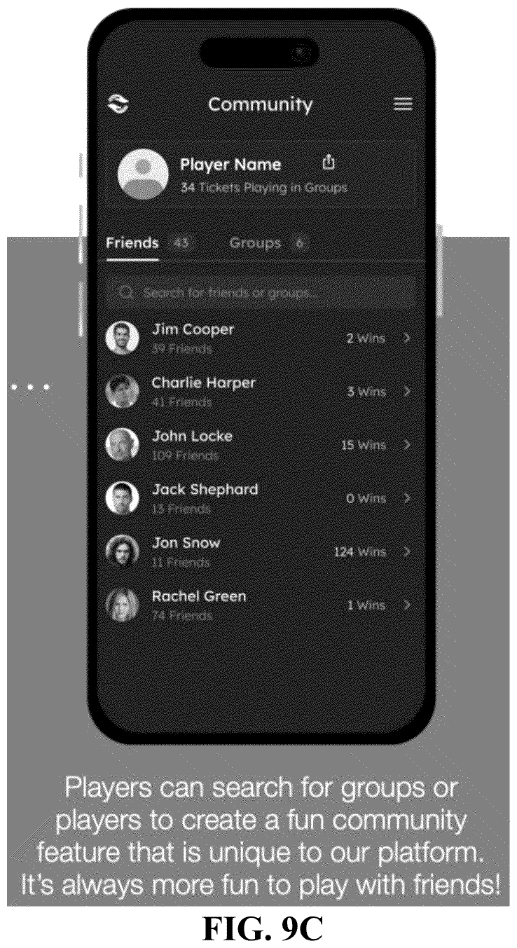

FIG. 9 is a flowchart of an example of a technique 900 for creating a prize pool or a group and receiving participants to join the prize pool or group for an online game of chance. This can be also referred to as group play. Implementations illustrated in FIG. 9 can be implemented by a server (e.g., the server 140), the computing device 200, the participant device 120, a Hex-Perpetual engine, and/or another processing-based device. Further, implementations illustrated in FIG. 9 can implement, be implemented by, or in conjunction with the implementations described above with respect to FIGS. 1-8. The technique 900 can enable users to pool resources and share in prize winnings. The technique 900 can include a pool creating processing portion 910 which enables a user to create a pool including setting a pool type, assigning an administrator, establishing an identifier, and generating invitation links. A pool invitation processing portion 920 enables the user (admin) to search, find, and send invitations to potential players to join via a closed group processing portion 925. Other users can review open-type pools and join accordingly via open pool processing portion 930. An example of group play is shown in FIGS. 9A-C.

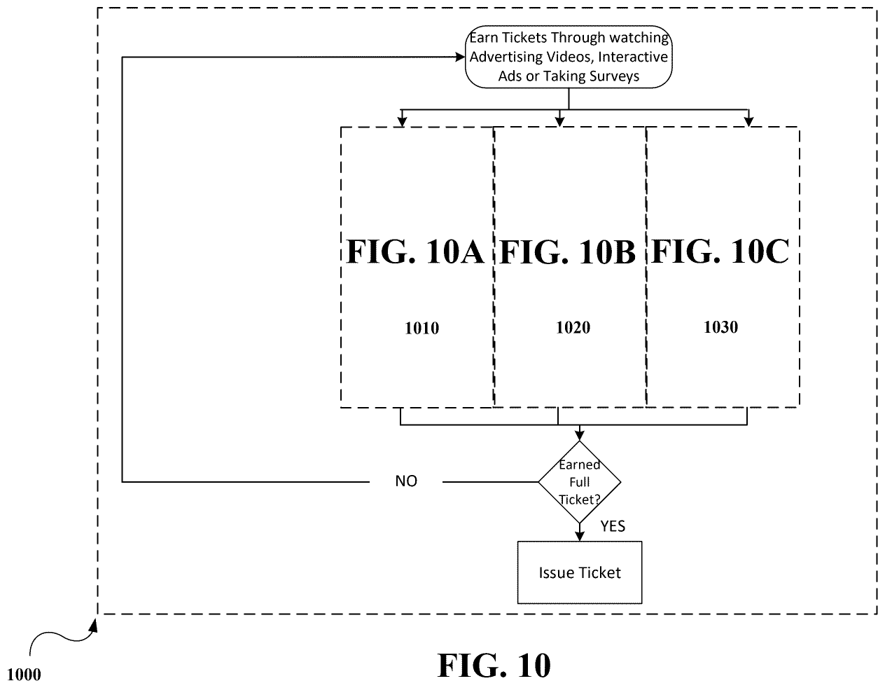

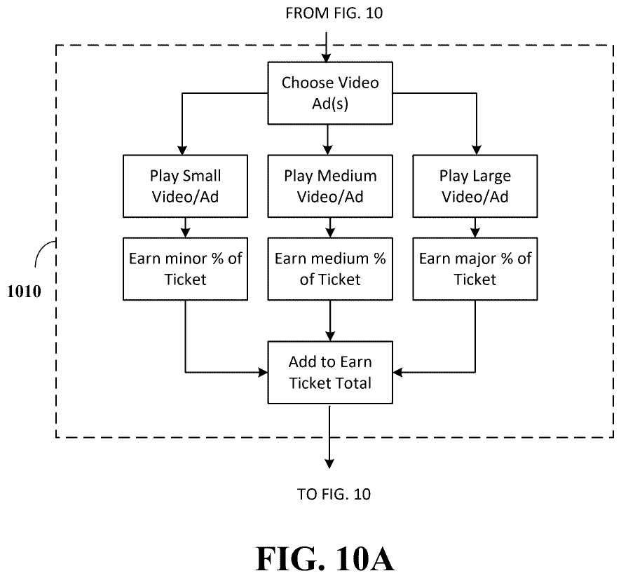

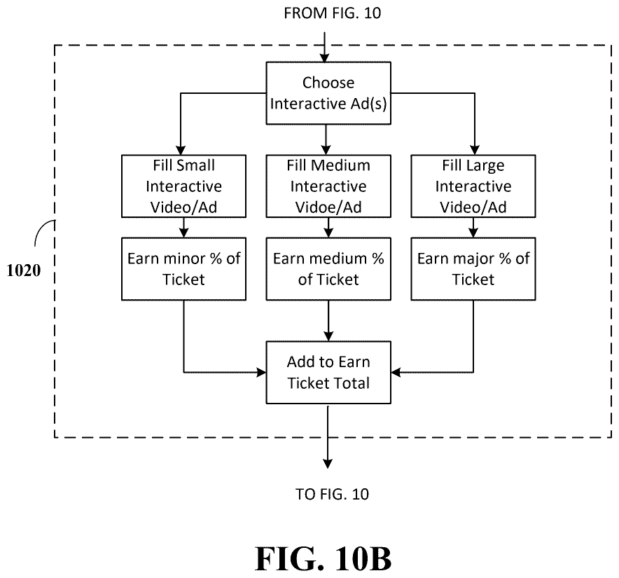

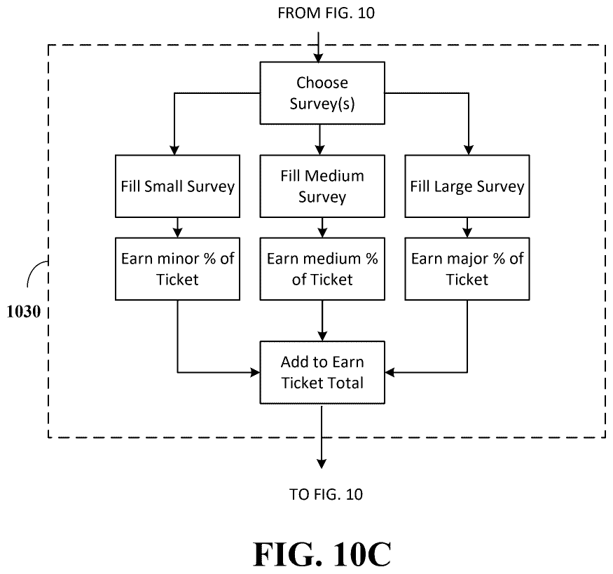

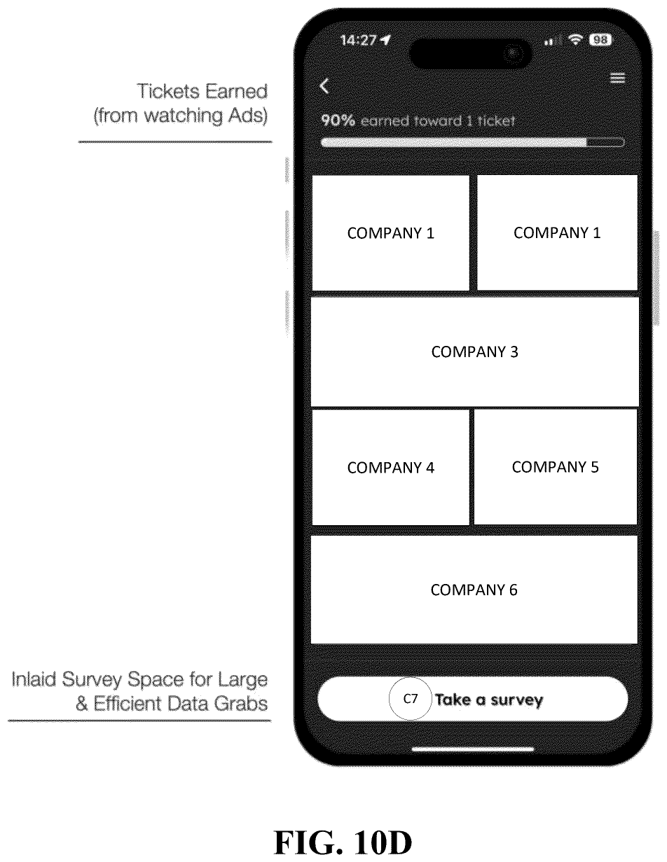

FIGS. 10 and 10A-10B are flowcharts of an example of a technique 1000 for utilizing advertisement and surveys to promote an online game of chance. FIGS. 10 and 10A-10C are inter-connected flowcharts. Implementations illustrated in FIGS. 10 and 10A-10B can be implemented by a server (e.g., the server 140), the computing device 200, the participant device 120, and/or another processing-based device. Further, implementations illustrated in FIGS. 10 and 10A-10B can implement, be implemented by, or in conjunction with the implementations described above with respect to FIGS. 1-9. The technique 1000 enables users to earn tickets for the game and/or a portion or percentage of a ticket by watching advertisements and/or videos, participating in interactive videos, games, advertisements, and the like, and/or participating in surveys. An advertisement and/or video watching processing portion 1010 can receive user input that the user wants to watch an advertisement and/or video to earn tickets. The length of the advertisement and/or video can determine the number of tickets and/or a percentage of a ticket the user can earn. An interactive video and/or advertisement processing portion 1020 can receive user input that the user wants to participate in an interactive video and/or advertisement to earn tickets. The length of the video and/or advertisement and level of interactivity can determine the number of tickets and/or a percentage of a ticket the user can earn. A survey participating processing portion 1030 can receive user input that the user wants to take part in a survey to earn tickets. The length of the survey can determine the number of tickets and/or a percentage of a ticket the user can earn. In each case, full participation is required to earn the designated number of tickets and/or the percentage of a ticket. An example of an advertisement page or screen is shown in FIG. 10D.

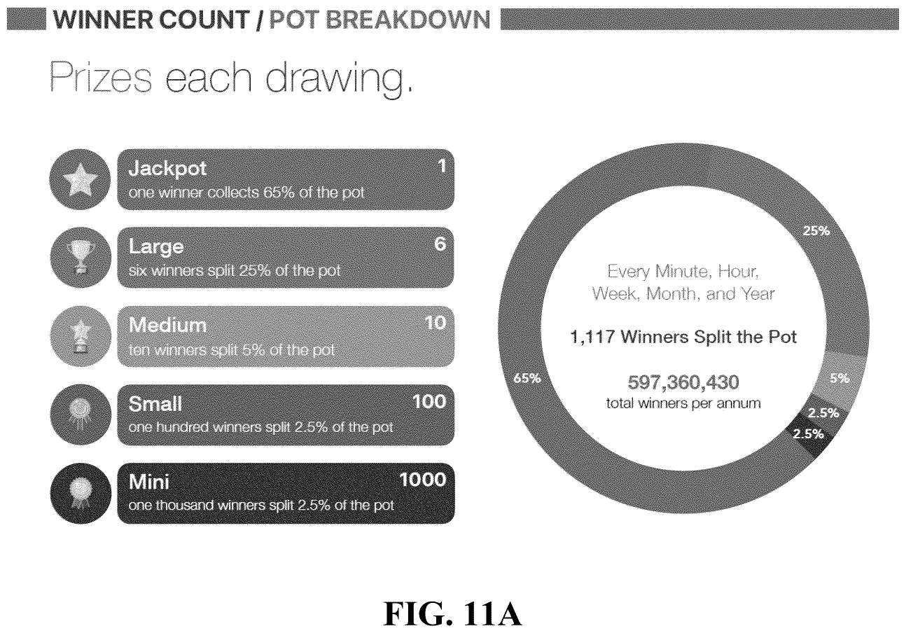

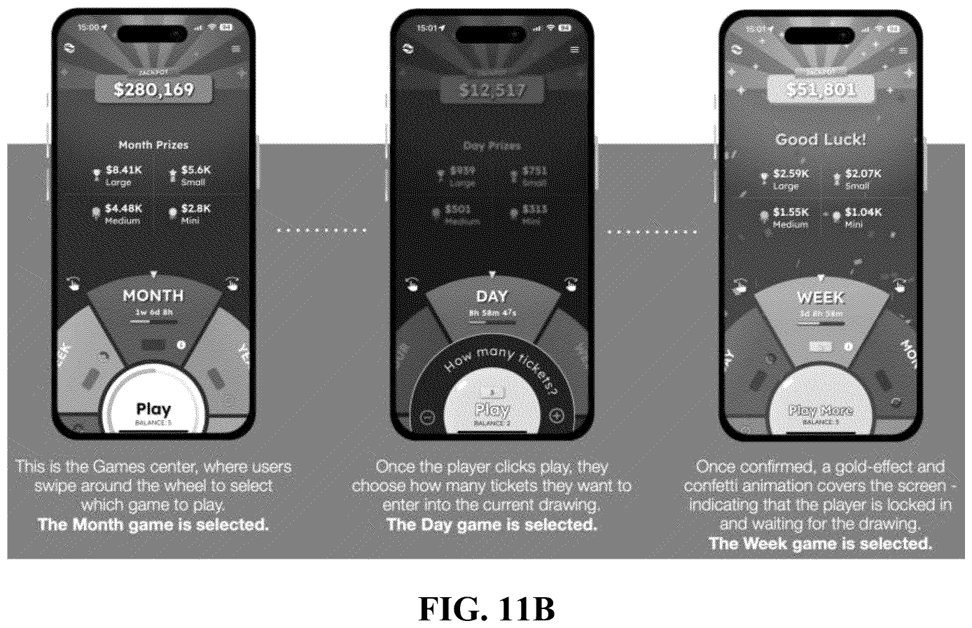

FIGS. 11A and 11B are illustrations that illustrate an example breakdown of total prize(s) and prizes for a minute game, an hour game, a week game, a month game, and a year game of the Hex-Perpetual games, and a user interface which participants can interact with to participate in the Hex-Perpetual game, respectively. Implementations illustrated in FIGS. 11A and 11B can be implemented by a server (e.g., the server 140), the computing device 200, the participant device 120, and/or another processing-based device. Further, implementations illustrated in FIGS. 11A and 11B can implement, be implemented by, or in conjunction with the implementations described above with respect to FIGS. 1-10C.

Described herein is a method for operating online game of chance. The method includes receiving purchases of chances for winning prizes for online games of chance, initiating randomized drawings for winning the prizes for the online games of chance, and selecting, based on the randomized drawings, at least one prize winner for each cycle of the online games of chance, where the online games of chance comprise at least two independent games including a first game and a second game, where the first game is played continuously for first cycles with each cycle having a first time duration, where the second game is played continuously for second cycles with each cycle having a second time duration, where selecting the at least one prize winner for each cycle of the online games of chance includes selecting a respective prize winner for each cycle of the first game at end of the first time duration and selecting a respective prize winner for each cycle of the second game at end of the second time duration, where standardized time is used for each cycle of the first game and each cycle of the second game such that each cycle of a respective game has a same start time and a same end time for participants across different regions or different countries.

In implementations, the online games of chance are games of chance based on the standardized time, wherein the first time duration is one minute and the second time duration is one hour. In implementations, at least one or more cycles of the first cycles overlap in time with at least one or more cycles of the second cycles. In implementations, the purchases of chances can be utilized toward participating in one or more of the online games of chance, wherein such participation can be subscribed to be initiated on a regular basis. In implementations, the purchases of chances can be utilized toward participating in one or more of the online games of chance, wherein such participation can be configured to be initiated at a custom date. In implementations, the custom date for the participation corresponds to a respective time based on a location of a participant device that is used to participate in the online game of chance, and the method further comprises converting or mapping the respective time to the standardized time for participating in the one or more of the online games of chance such that the participant can participate according to a respective time zone in which the participant is located. In implementations, the method further includes determining a historical frequency of winning at least one of the prizes based on geographical regions, and outputting the historical frequency on a display of a participant device. In implementations, the method further includes determining a real-time participation level for at least one of the online games of chance and a monetary value of a respective prize based on the real-time participation level, and outputting a notification that indicates the real-time participation level and the monetary value of the respective prize on a display of a participant device. In implementations, the method further includes determining a historical frequency of winning at least one of the prizes based on geographical regions, determining a real-time participation level for at least one of the online games of chance and a monetary value of a respective prize based on the real-time participation level, and responsive to determining the real-time participation level and the monetary value of the prize, outputting a notification that indicates the historical frequency, the real-time participation level, and the monetary value of the prize on a display of a participant device. In implementations, the method further includes determining a historical participation level of at least one of the online games of chance based on geographical regions, determining a real-time participation level for at least one of the online games of chance and a monetary value of the prize based on the real-time participation level, and responsive to determining the real-time participation level and the monetary value of the prize, outputting a notification that indicates the historical participation level, the real-time participation level, and the monetary value of the prize on a display of a participant device. In implementations, the method further includes determining a region with most winners of the prizes, and outputting the region on a map on a display of a participant device. In implementations, the method further includes responsive to determining that a participant did not win at least one of the prizes, outputting a notification on a display of a participant device, wherein the notification indicates the participant to participate in a next game that occurs in a next respective cycle of the online games of chance. In implementations, the method further includes outputting the standardized time for display on an interface of a participant device, wherein the standardized time corresponds to a Greenwich mean time.

Described herein is a non-transitory computer readable medium storing instructions operable to cause one or more processors to perform operations for executing or operating an online game of chance. The operations include receiving purchases of chances for winning prizes for online games of chance, initiating randomized drawings for winning the prizes for the online games of chance, and selecting, based on the randomized drawings, at least one prize winner for each cycle of the online games of chance, where the online games of chance comprise at least two independent games including a first game and a second game, where the first game is played continuously for first cycles with each cycle having a first time duration, where the second game is played continuously for second cycles with each cycle having a second time duration, where selecting the at least one prize winner for each cycle of the online games of chance includes selecting a respective prize winner for each cycle of the first game at end of the first time duration and selecting a respective prize winner for each cycle of the second game at end of the second time duration, where standardized time is used for each cycle of the first game and each cycle of the second game such that each cycle of a respective game has a same start time and a same end time for participants across different regions or different countries.

In implementations, the online games of chance are games of chance based on the standardized time, wherein the first time duration is one minute and the second time duration is one hour. In implementations, at least one or more cycles of the first cycles overlap in time with at least one or more cycles of the second cycles. In implementations, the purchases of chances can be utilized toward participating in one or more of the online games of chance, wherein such participation can be subscribed to be initiated on a regular basis. In implementations, the purchases of chances can be utilized toward participating in one or more of the online games of chance, wherein such participation can be configured to be initiated at a custom date.

Described herein is a system which includes a memory subsystem storing instructions and a processing circuitry configured to execute the instructions to: receive purchases of chances for winning prizes for online games of chance, initiate randomized drawings for winning the prizes for the online games of chance, select, based on the randomized drawings, at least one prize winner for each cycle of the online games of chance, where the online games of chance comprise at least two independent games including a first game and a second game, where the first game is played continuously for first cycles with each cycle having a first time duration, where the second game is played continuously for second cycles with each cycle having a second time duration, where to select the at least one prize winner for each cycle of the online games of chance includes to select a respective prize winner for each cycle of the first game at end of the first time duration and select a respective prize winner for each cycle of the second game at end of the second time duration, and wherein standardized time is used for each cycle of the first game and each cycle of the second game such that each cycle of a respective game has a same start time and a same end time for participants across different regions or different countries.

In implementations, the online games of chance are games of chance based on the standardized time, wherein the first time duration is one minute and the second time duration is one hour, and at least one or more cycles of the first cycles overlap in time with at least one or more cycles of the second cycles.

It should be noted that the applications and implementations of this disclosure are not limited to the examples, and alternations, variations, or modifications of the implementations of this disclosure can be achieved for any computation environment.

It can be appreciated that various changes can be made therein without departing from the spirit and scope of the disclosure. Moreover, the various features of the implementations described herein are not mutually exclusive. Rather any feature of any implementation described herein can be incorporated into any other suitable implementation.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Flutter, DART, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, can be understood as corresponding to a functional unit implemented using software, hardware (e.g., an integrated circuit, such as an ASIC), or a combination of software and hardware. In certain contexts, such systems or mechanisms can be understood to be a processor-implemented software system or processor-implemented software mechanism that is part of or callable by an executable program, which can itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

As used herein, the term “memory subsystem” includes one or more memories, where each memory can be a computer-readable medium. A memory subsystem can encompass memory hardware units (e.g., a hard drive or a disk) that store data or instructions in software form. Alternatively or in addition, the memory subsystem can include data or instructions that are hard-wired into processing circuitry.

As used herein, processing circuitry includes one or more processors. The one or more processors can be arranged in one or more processing units, for example, a central processing unit (CPU), a graphics processing unit (GPU), or a combination of at least one of a CPU or a GPU.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for operating online game of chance, the method comprising:
receiving purchases of chances for winning prizes for online games of chance;
initiating randomized drawings for winning the prizes for the online games of chance; and
selecting, based on the randomized drawings, at least one prize winner for each cycle of the online games of chance,
wherein the online games of chance comprise at least two independent games including a first game and a second game,
wherein the first game is played continuously for first cycles with each cycle having a first time duration;
wherein the second game is played continuously for second cycles with each cycle having a second time duration;
wherein selecting the at least one prize winner for each cycle of the online games of chance includes selecting a respective prize winner for each cycle of the first game at end of the first time duration and selecting a respective prize winner for each cycle of the second game at end of the second time duration, and
wherein standardized time is used for each cycle of the first game and each cycle of the second game such that each cycle of a respective game has a same start time and a same end time for participants across different regions or different countries.

2. The method of claim 1, wherein the online games of chance are games of chance based on the standardized time, wherein the first time duration is one minute and the second time duration is one hour.

3. The method of claim 2, wherein at least one or more cycles of the first cycles overlap in time with at least one or more cycles of the second cycles.

4. The method of claim 2, wherein the purchases of chances can be utilized toward participating in one or more of the online games of chance, wherein such participation can be subscribed to be initiated on a regular basis.

5. The method of claim 2, wherein the purchases of chances can be utilized toward participating in one or more of the online games of chance, wherein such participation can be configured to be initiated at a custom date.

6. The method of claim 5, wherein:
the custom date for the participation corresponds to a respective time based on a location of a participant device that is used to participate in the online game of chance; and
the method further comprises converting or mapping the respective time to the standardized time for participating in the one or more of the online games of chance such that the participant can participate according to a respective time zone in which the participant is located.

7. The method of claim 1, further comprising:
determining a historical frequency of winning at least one of the prizes based on geographical regions; and
outputting the historical frequency on a display of a participant device.

8. The method of claim 1, further comprising:
determining a real-time participation level for at least one of the online games of chance and a monetary value of a respective prize based on the real-time participation level; and
outputting a notification that indicates the real-time participation level and the monetary value of the respective prize on a display of a participant device.

9. The method of claim 1, further comprising:
determining a historical frequency of winning at least one of the prizes based on geographical regions;
determining a real-time participation level for at least one of the online games of chance and a monetary value of a respective prize based on the real-time participation level; and
responsive to determining the real-time participation level and the monetary value of the prize, outputting a notification that indicates the historical frequency, the real-time participation level, and the monetary value of the prize on a display of a participant device.

10. The method of claim 1, further comprising:
determining a historical participation level of at least one of the online games of chance based on geographical regions;
determining a real-time participation level for at least one of the online games of chance and a monetary value of the prize based on the real-time participation level; and
responsive to determining the real-time participation level and the monetary value of the prize, outputting a notification that indicates the historical participation level, the real-time participation level, and the monetary value of the prize on a display of a participant device.

11. The method of claim 1, further comprising:
determining a region with most winners of the prizes; and
outputting the region on a map on a display of a participant device.

12. The method of claim 1, further comprising:
responsive to determining that a participant did not win at least one of the prizes, outputting a notification on a display of a participant device, wherein the notification indicates the participant to participate in a next game that occurs in a next respective cycle of the online games of chance.

13. The method of claim 1, further comprising:
outputting the standardized time for display on an interface of a participant device, wherein the standardized time corresponds to a Greenwich mean time.

14. A non-transitory computer readable medium storing instructions operable to cause one or more processors to perform operations for executing or operating an online game of chance, the operations comprising:
receiving purchases of chances for winning prizes for online games of chance;
initiating randomized drawings for winning the prizes for the online games of chance; and
selecting, based on the randomized drawings, at least one prize winner for each cycle of the online games of chance,
wherein the online games of chance comprise at least two independent games including a first game and a second game,
wherein the first game is played continuously for first cycles with each cycle having a first time duration,
wherein the second game is played continuously for second cycles with each cycle having a second time duration,
wherein selecting the at least one prize winner for each cycle of the online games of chance includes selecting a respective prize winner for each cycle of the first game at end of the first time duration and selecting a respective prize winner for each cycle of the second game at end of the second time duration, and
wherein standardized time is used for each cycle of the first game and each cycle of the second game such that each cycle of a respective game has a same start time and a same end time for participants across different regions or different countries.

15. The non-transitory computer readable medium of claim 14, wherein the online games of chance are games of chance based on the standardized time, wherein the first time duration is one minute and the second time duration is one hour.

16. The non-transitory computer readable medium of claim 15, wherein at least one or more cycles of the first cycles overlap in time with at least one or more cycles of the second cycles.

17. The non-transitory computer readable medium of claim 15, wherein the purchases of chances can be utilized toward participating in one or more of the online games of chance, wherein such participation can be subscribed to be initiated on a regular basis.

18. The non-transitory computer readable medium of claim 15, wherein the purchases of chances can be utilized toward participating in one or more of the online games of chance, wherein such participation can be configured to be initiated at a custom date.

19. A system comprising:
a memory subsystem storing instructions; and
processing circuitry configured to execute the instructions to:
receive purchases of chances for winning prizes for online games of chance;
initiate randomized drawings for winning the prizes for the online games of chance;
select, based on the randomized drawings, at least one prize winner for each cycle of the online games of chance,
wherein the online games of chance comprise at least two independent games including a first game and a second game,
wherein the first game is played continuously for first cycles with each cycle having a first time duration,
wherein the second game is played continuously for second cycles with each cycle having a second time duration,
wherein to select the at least one prize winner for each cycle of the online games of chance includes to select a respective prize winner for each cycle of the first game at end of the first time duration and select a respective prize winner for each cycle of the second game at end of the second time duration, and
wherein standardized time is used for each cycle of the first game and each cycle of the second game such that each cycle of a respective game has a same start time and a same end time for participants across different regions or different countries.

20. The system of claim 19, wherein:
the online games of chance are games of chance based on the standardized time, wherein the first time duration is one minute and the second time duration is one hour; and
at least one or more cycles of the first cycles overlap in time with at least one or more cycles of the second cycles.
